(19) United States
(12) Patent Application Publication
(10) Pub. No.: US 2017/0362786 A1
(43) Pub. Date: Dec. 21, 2017

(54) TRAFFIC CONE DISPENSING AND RETRIEVING APPARATUS

(71) Applicant: Simon Betson, Athy (IE)

(72) Inventor: Simon Betson, Athy (IE)

(21) Appl. No.: 15/692,370

(22) Filed: Aug. 31, 2017

Related U.S. Application Data
(63) Continuation-in-part of application No. 14/249,537, filed on Apr. 10, 2014, now Pat. No. 9,771,695.

(30) Foreign Application Priority Data
Apr. 10, 2013 (GB) 1306546.1

(51) Int. Cl. E01F 9/70; B08B 13/00; B60P 1/44; E01F 9/654; E01F 9/692

(52) U.S. Cl. CPC E01F 9/70; B60P 1/4485; E01F 9/654; B08B 13/00; E01F 9/692

(57) ABSTRACT

An apparatus for dispensing cones onto a surface and for retrieving cones from the surface includes a cone transfer device having a tower with a platform moveable to and from a lower transfer position for dispensing cones onto the surface and for retrieving cones from the surface. The platform is movable in a vertical direction between the lower transfer position and an upper transfer position for receiving a stack of cones from a storage area and for returning a stack of cones to the storage area. The tower includes a device for holding one or more cones in an elevated position and for releasing cones onto and receiving cones from the platform in the elevated position. The apparatus may include a lamp transfer device for attaching a lamp unit to a cone when the cone is dispensed and for removing the lamp unit from the cone when the cone is retrieved. The apparatus may include a cone washing device for washing a cone when the cone is retrieved and/or when the cone is dispensed.

### BACKGROUND OF THE INVENTION

This invention relates to apparatus for dispensing traffic cones from a vehicle onto a road surface and for retrieving the cones from the road surface onto the vehicle.

Traffic cones are used to provide temporary traffic control, for example when carrying out road repairs or improvements or following an accident. When large numbers of traffic cones are required, for example to create temporary lanes on a motorway, manually placing the cones along the road and later picking up the cones is time consuming and dangerous due to the close proximity of moving traffic. Also, the cones are heavy and awkward to handle making the work of manually placing the cones on the road and picking the cones up strenuous with the risk of injury.

There is a need for apparatus that can dispense cones onto a road surface and retrieve cones from a road surface that avoids manually placing the cones on the road surface and picking the cones up from the road surface.

In one aspect, the invention provides apparatus for dispensing cones onto a surface and for retrieving cones from the surface, the apparatus including a cone transfer device for transferring cones between a vehicle and the surface.

The apparatus may comprise a tower having a platform moveable to and from a lower transfer position for dispensing cones onto the road and for retrieving cones from the road. The platform may be movable between the lower transfer position and an upper transfer position for receiving cones from a storage area and for returning cones to the storage area. The upper transfer position may be located above, preferably substantially directly above the lower transfer position. The upper transfer position may be spaced substantially vertically above the lower transfer position.

The platform may receive a stack of cones from the storage area. The apparatus may include a device for releasing cones from the stack onto the platform individually or in multiples of two or more cones.

In one embodiment, the device comprises one or more gripping fingers. The gripping fingers may be movable between a closed position and an open position. The gripping device may retain cones in an elevated position from which cones can be released onto the platform individually or in multiples of two or more cones. Sets of gripping fingers may be provided for retaining individual cones in the elevated position.

In another embodiment, the device comprises on or more clamping bars. The clamping bars may be movable between a closed position and an open position. The clamping device may retain cones in an elevated position from which cones can be released onto the platform individually or in multiples of two or more cones.

The apparatus may be provided with a lamp transfer device for attaching a lamp unit to a cone when the cone is dispensed and for removing the lamp unit from the cone when the cone is retrieved.

The apparatus may be provided with a cone washing device for washing a cone when the cone is retrieved and/or when the cone is dispensed.

The platform may include an elevator for positioning the cone for attaching and removing the lamp unit and/or for washing the cone. The elevator may adjust a vertical position of the cone. The elevator may adjust an angular position of the cone. The elevator may lift and rotate the cone.

The elevator may be configured to engage a hole in the base of a cone. The engagement of the elevator in the hole may assist in securing the elevator to the cone and/or in positioning the cone on the platform. The portion of the elevator engaging in the hole and/or the hole may taper in towards the top of the base.

The apparatus may be mounted on a vehicle or a trailer towed by a vehicle. The tower may be movable transverse to the direction of movement of the vehicle.

The apparatus may include a device for aligning the platform with a cone to be retrieved. The alignment device may comprise guide bars defining a channel for guiding a cone towards the platform.

The apparatus may include a device for tilting a cone to be retrieved. The tilting device may comprise one or more tilt bars configured to engage an upper end of the cone to tilt the cone for retrieving the cone onto the platform.

The apparatus may include a device for retrieving a cone onto the platform. The retrieving device may engage an underside of a tilted cone and transfer the cone onto the platform.

In another aspect, the invention provides apparatus for dispensing cones onto a surface and for retrieving cones from the surface, the apparatus including a lamp transfer device for attaching a lamp unit to a cone and for retrieving the lamp unit from the cone.

The apparatus may include any feature of apparatus according to any other aspect of the invention.

In another aspect, the invention provides apparatus for dispensing cones onto a surface and for retrieving cones from the surface, the apparatus including a cone washing device for washing a cone.

The apparatus may include any feature of apparatus according to any other aspect of the invention.

In another aspect, the invention provides apparatus for dispensing cones onto a surface and for retrieving cones from the surface, the apparatus including one or more of a cone transfer device for transferring cones between a vehicle and the surface, a lamp transfer device for attaching a lamp unit to a cone and for retrieving the lamp unit from the cone, and a cone washing device for washing a cone

The apparatus may include any feature of apparatus according to any other aspect of the invention.

In another aspect, the invention provides a cone having a base and a body upstanding from the base, wherein the base is configured to provide access between the bases of stacked cones.

The base may be provided with one or more spacer formations for co-operating with the base of another cone to provide access between the bases. The base may have an underside and topside. The spacer formation may be provided on the underside of the base. Alternatively, the spacer formation may be provided on the topside of the base.

In another aspect, the invention provides a cone having a base and a body upstanding from the base, wherein the cone is provided with a light unit at an upper end of the body.

The light unit may be battery powered. The cone may be configured to interconnect light units of stacked cones. In this way, cones can be connected to a common power source for charging the batteries when the cones are stacked.

The light unit may include an housing for a light source. The housing may be a part of the body of the cone. The housing may form the upper end of the body. The housing may be made of a light transmitting material. The housing may be made of transparent or translucent plastic. The light source may be a light module received within the housing. The light module may be detachable.

In another aspect the invention provides a cone having a base and body, wherein the base is offset relative to the body.

Preferably the base is offset relative to a vertical axis through the body. It may be that the base protrudes from the body to a greater extent on at least one side of the body. When setting the cone down onto the road, for example to close off a lane, the offset cone base can be placed on the road with a protruding side of the base facing in towards the closed lane. As a result, the possibility of the base being driven over by passing traffic in the live lane is reduced compared to a regular based cone where the protruding base is not in the driver's line of vision, leaving it prone to being knocked over.

In another aspect the invention provides apparatus for dispensing cones onto a surface and for retrieving cones from the surface comprises a cone transfer device for transferring cones between a vehicle and the surface, the cone transfer device including a tower having a first platform and a second platform for dispensing cones onto the road and for retrieving cones from the road, the first platform being movable to and from a first transfer position, and the second platform being movable between the first transfer position and a second transfer position, and between outward and inward transfer positions to dispense cones onto the road and retrieve cones from the road, a device for tilting a cone and an anti-skid mechanism deployed when retrieving cones.

The first platform moves cones to and from the tower, while the second platform takes cones from the first platform to dispense onto the road and retrieves cones from the road to put them onto the first platform. This reduces the time taken by splitting the movement of the cones between the two platforms, rather than having one platform to perform all the movements.

The cones are typically hollow, and the first platform includes a securing member adapted to engage in the interior of a cone in order to stabilise it on the platform. The securing member may be movably mounted on the first platform between a lower position flush with the platform surface and a raised position in which it engages the interior of a cone. The securing member may be frusta-conical in order to engage securely in the cone. The securing member may be a turntable, for rotating the cones. The securing member may also be provided with gripping members movable into engagement with the interior of a cone. The gripping members preferably move radially into and out of engagement with the interior of the cone. The securing member and the gripping members ensure that a cone is securely held on the first platform, and may be used to pull a cone from the bottom of a stack of cones. The first platform is also provided with conveyor means, such as belts, to transfer cones onto and off the first platform.

The second platform may also be provided with conveyor means such as belts for transferring cones onto and off the second platform. Movement of the second platform is co-ordinated with movement of the cone tilting device and the anti-skid mechanism.

The cone tilting device preferably comprises a retractable toppler assembly, including a toppler collar adapted to engage the outside of a cone to start it tilting as it is retrieved. Movement of the collar may also operate switches to control movement of the second platform and the anti-skid mechanism.

The anti-skid mechanism conveniently comprises a slider mounted on the tower and movable inwardly and outwardly. The slider may carry an anti-skid arm which can be lowered to contact a cone being retrieved to stop it skidding on the road as it is tilted by the cone tilting device.

In yet another aspect the invention provides apparatus for dispensing cones onto a surface and for retrieving cones from the surface comprises a cone transfer device for transferring cones between a vehicle and the surface, the cone transfer device including a tower having a first platform movable to and from a first transfer position for dispensing cones onto the road and for retrieving cones from the road, and a transfer assembly movable independently of the first platform to transfer a stack of cones between the tower and the vehicle.

Providing the assembly to move the cones between the tower and the vehicle independently of the first platform also reduces the time taken in dispensing and retrieving the cones, as the platform does not need to transfer the cones between the tower and the vehicle as well as dispensing and retrieving them.

Conveniently the transfer assembly comprises a clamp assembly mounted in the tower and movable within the tower, and away from the tower towards the vehicle. The clamping bars may be movable between a closed position and an open position. The clamping device may retain cones in an elevated position from which cones can be released onto the platform individually or in multiples of two or more cones.

The clamp assembly can retain a stack of cones independently of the first platform. The first platform therefore moves cones between the first transfer position and the clamp assembly, and the clamp assembly moves the cones between the tower and the vehicle.

The vehicle may be provided with a shuttle movable transverse to the direction of movement of the vehicle for transferring stacks of cones between a storage area and the tower. The transfer assembly may then pick up a stack of cones from the shuttle and return a stack to the shuttle.

In yet another aspect the invention provides apparatus for dispensing cones onto a surface and for retrieving cones from the surface comprises a cone transfer device for transferring cones between a vehicle and the surface, the cone transfer device including a tower having a first platform movable to and from a lower transfer position for dispensing cones onto the road and for retrieving cones from the road, the first platform including a securing mechanism for engaging the internal surface of a cone.

The securing mechanism ensures that a cone is held securely on the platform, whether it is being dispensed or retrieved. It also ensures that a cone can be removed from the base of a stack of cones for dispensing in a timely manner, even if it is not freely movable.

Conveniently the securing mechanism includes a securing member adapted to engage in the interior of a cone in order to stabilise it on the first platform. The securing member may be movably mounted on the first platform between a lower position flush with the platform surface and a raised position in which it engages the interior of a cone. The securing member may be frusto-conical in order to engage securely in the cone. The securing member may also be provided with gripping members movable into engagement with the interior of a cone. The gripping members preferably move radially into and out of engagement with the interior of the cone. The securing member and the gripping members ensure that a cone is securely held on the first platform, and may be used to pull a cone from the bottom of a stack of cones.

### BRIEF DESCRIPTION OF THE DRAWINGS

These and other features, benefits and advantages of the invention according to each of the aspects will be apparent from the description of exemplary embodiments with reference to the accompanying drawings, wherein:

FIG. 1 is a diagrammatic perspective view of apparatus embodying the invention with the tower in a mid-position;

FIG. 2 is a diagrammatic perspective view of the apparatus of FIG. 1 with the tower in an end position;

FIG. 3 is a diagrammatic perspective view of the apparatus of FIG. 1 with the tower in another end position;

FIG. 4 is a perspective view of the guide rails and tower frame;

FIG. 5 is a perspective view of the tower platform;

FIGS. 6 to 9 show the apparatus retrieving a cone from a surface;

FIGS. 10 to 12 show the cone washing device;

FIGS. 13 and 14 show the lamp transfer device;

FIG. 15 shows a cone;

FIG. 16 shows another cone;

FIGS. 17 and 18 show a modification of the apparatus;

FIG. 19 shows another modification of the apparatus;

FIGS. 20 to 25 show another modification of the apparatus;

FIG. 26 shows another cone;

FIG. 27 is a side view of the tower of the apparatus of FIG. 1 showing a cone in a dispense position;

FIG. 28 is a perspective view of a first platform;

FIG. 29 is similar to FIG. 28 with a turntable of the platform raised;

FIG. 30 is a perspective view of the tower showing first and second platforms and an open clamp assembly for cones;

FIG. 31 shows the tower in a similar position to FIG. 6 with the first platform supporting a stack of cones;

FIG. 32 is a side view of the tower of the apparatus in a cone stack transfer position;

FIG. 33 is a perspective view of the lower part of the tower with the components in a retracted position; and

FIGS. 34 to 40 show the components in the sequence of positions for retrieving a cone.

### DETAILED DESCRIPTION OF THE INVENTION

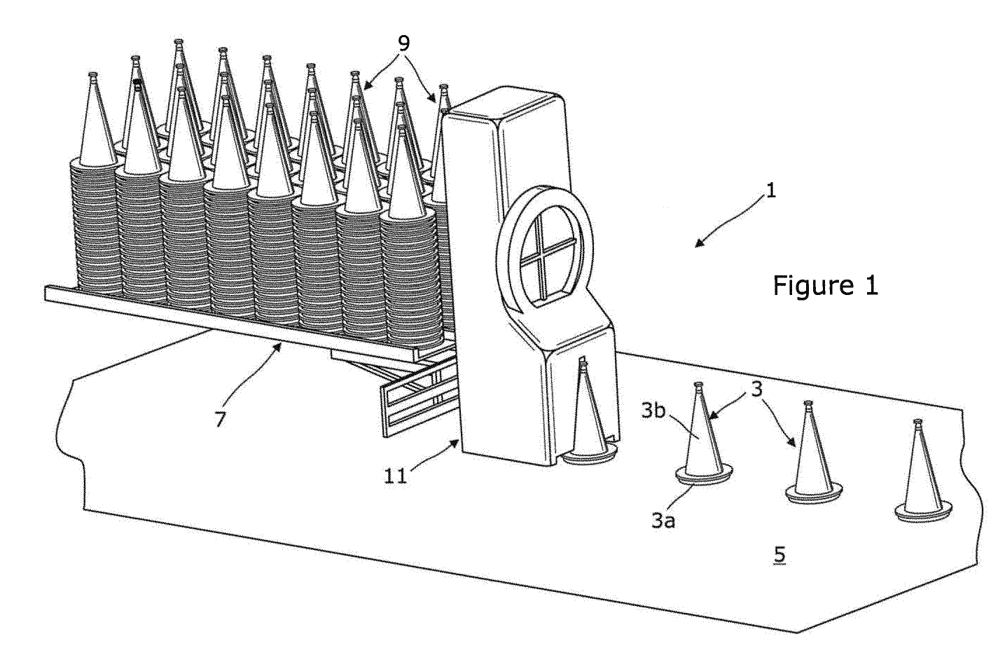

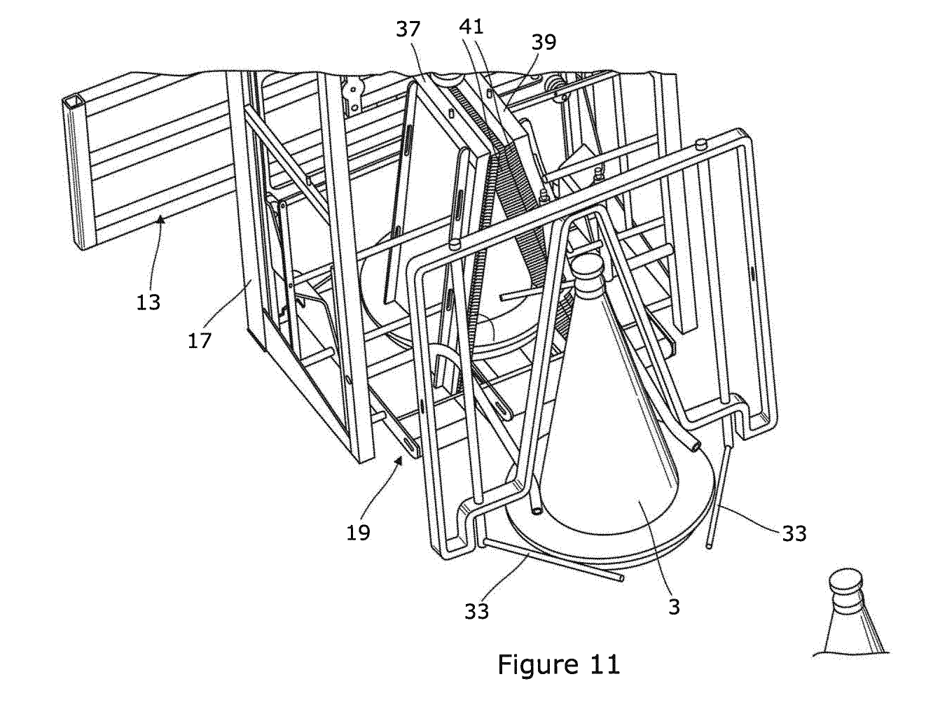

Referring first to FIGS. 1 to 14 of the drawings, apparatus 1 for dispensing cones 3 onto a road 5 or similar surface and retrieving the cones 3 from the road 5 is shown.

Each cone 3 has a base 3a and a conical body 3b upstanding from the base 3a. The body 3b is hollow and can be accessed through a central hole in the base 3a. The base 3a may be circular or substantially circular in plan view.

The apparatus 1 is mounted at a rear end of a flat bed storage area 7 on which stacks 9 of cones 3 are stored. The flat bed storage area 7 may be an integral part of a vehicle or may be separate unit towed by the vehicle.

The stacks 9 are arranged in longitudinal rows extending from the rear end to the front end of the flat bed storage area 7. The stacks 9 in each row are located on a conveyor for moving the stacks as described later.

In this embodiment there are three rows with eight stacks 9 in each row and twenty five cones 3 in each stack 9 giving a total of six hundred (600) cones 3 for use. The number of rows and the number of stacks 9 in each row and the number of cones 3 in each stack 9 may be varied according to requirements.

The apparatus 1 includes a tower 11 mounted on guide rails 13 secured at the rear end of the flat bed storage area 7 by one or more brackets 15. The guide rails 13 extend horizontally across the back of the flat bed storage area 7 transverse to the direction of movement of a vehicle provided with the flat bed storage area 7. The tower 11 is mounted on the guide rails 13 for sliding movement transverse to the direction of movement of the vehicle. The tower 11 may also be movable up and down between a lowered, working position close to the road 5 for dispensing/retrieving cones 3 and a raised position when not dispensing/retrieving cones so as to be a safe height above the road 5 for travelling.

A motor (not shown) such as a stepper motor may be provided to power traversing movement of the tower 11 relative to the guide rails 13. The motor may be controlled from a control unit (not shown) for accurately positioning the tower 11. Any suitable control unit may be employed including, but not limited to, electronic devices such as computers, laptops, palmtops and similar devices.

The control unit may be operated via a user interface from the driver's cab. Alternatively or additionally, the control unit may be operated via a user interface on the tower 11. Alternatively or additionally, the control unit may be operated via a hand held user interface such as a remote controller. The control unit may communicate with the motor via a wireless link to control movement of the tower 11. The control unit may include a memory, for example for storing factory settings. The control unit may be programmable allowing the user to select and/or change operation of the apparatus.

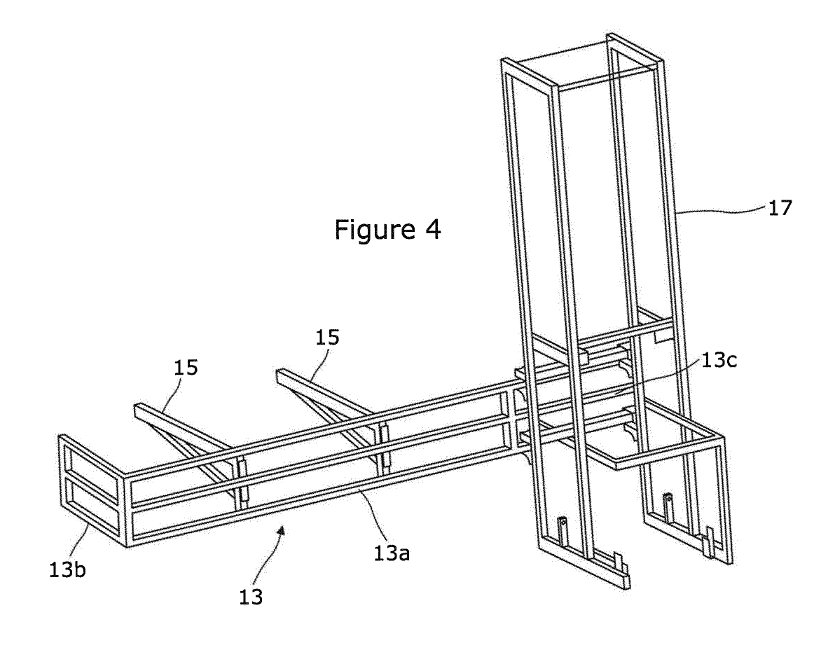

The guide rails 13 include a centre section 13a and end sections 13b, 13c. The centre section 13a has a width approximately equal to the width of the flat bed storage area 7. The end sections 13b, 13c are connected to the centre section by hinges for pivotal movement between a stowed position along the side of the flat bed storage area 7 substantially at right angles to the centre section 13a and a deployed position extending parallel to the centre section 13a. End section 13b is shown in the stowed position and end section 13c is shown in the deployed position in FIG. 4.

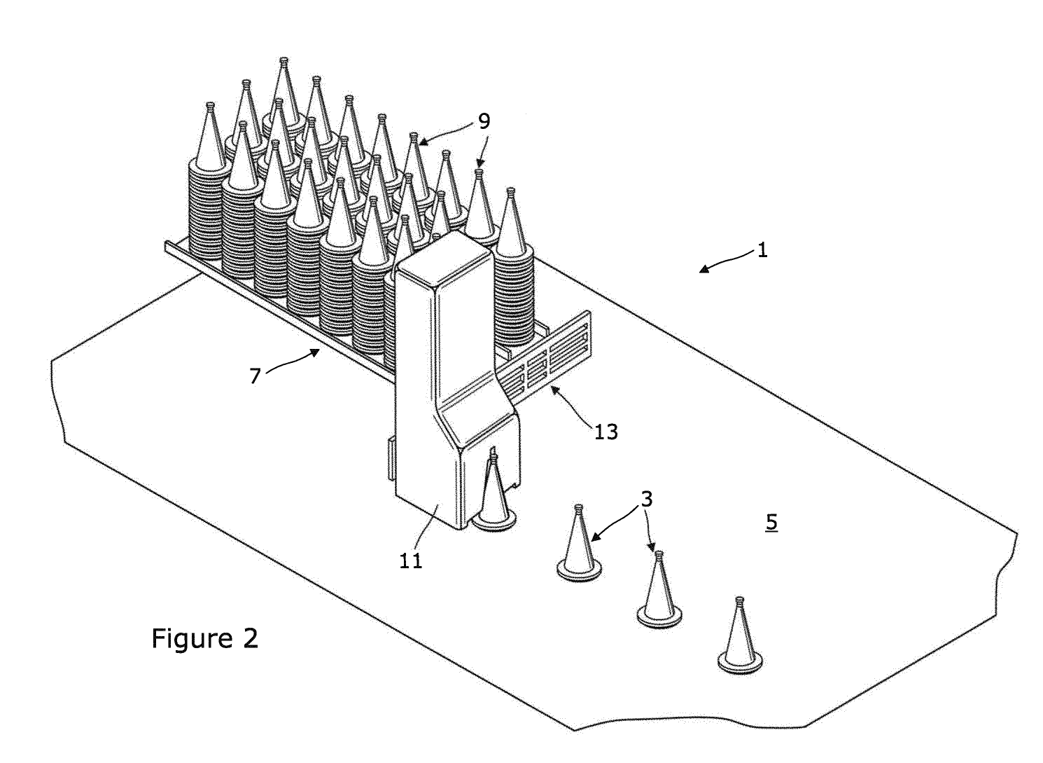

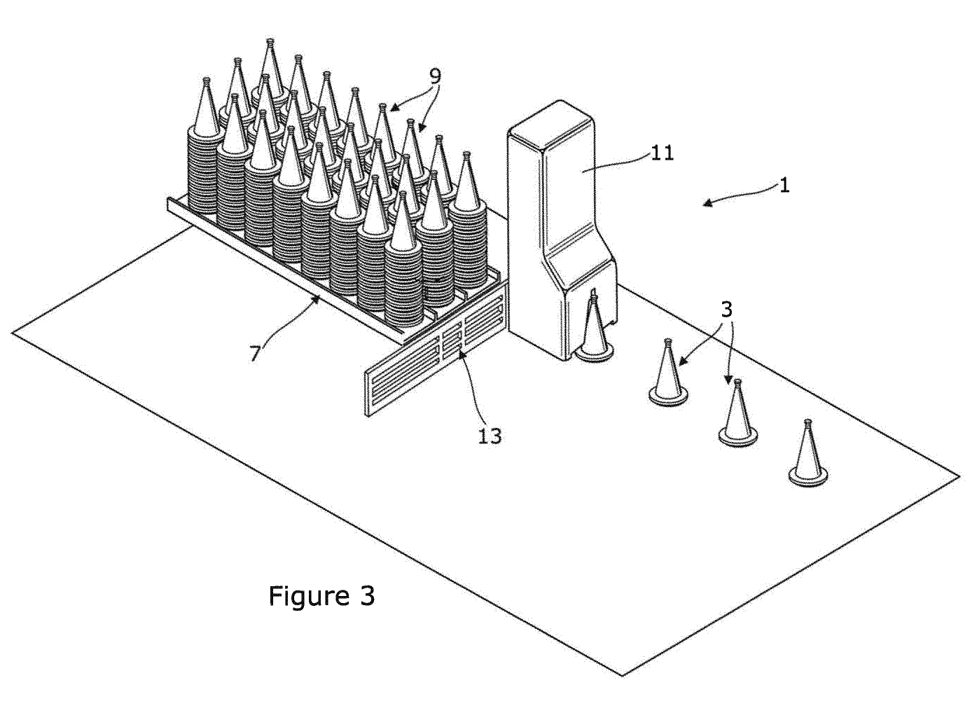

In the deployed position, the end sections 13b, 13c increase the width of the guide rails 13 to extend beyond the sides of the flat bed storage area 7 and allow movement of the tower 11 transverse to the direction of movement of the vehicle from a mid-position shown in FIG. 1 to the end positions shown in FIGS. 2 and 3. In the end positions the tower 11 is located outboard of the flat bed storage area 7. The tower 11 can be moved between the end positions for dispensing and retrieving cones 3 with the tower 11 located in either end position or any intervening position between the end positions.

Successive cones 3 may be set down at the same position to form a line following the direction of the vehicle by maintaining the tower 11 at the same position while dispensing cones 3. Alternatively, successive cones 3 may be set down at positions offset from one another across the width of the guide rails 13 to form a line that tapers from one side of the vehicle to the other by moving the tower 11 from one end position to the other end position while dispensing cones 3. Such tapered line may be provided at the start and end of a section of road along which the cones 3 are to be deployed.

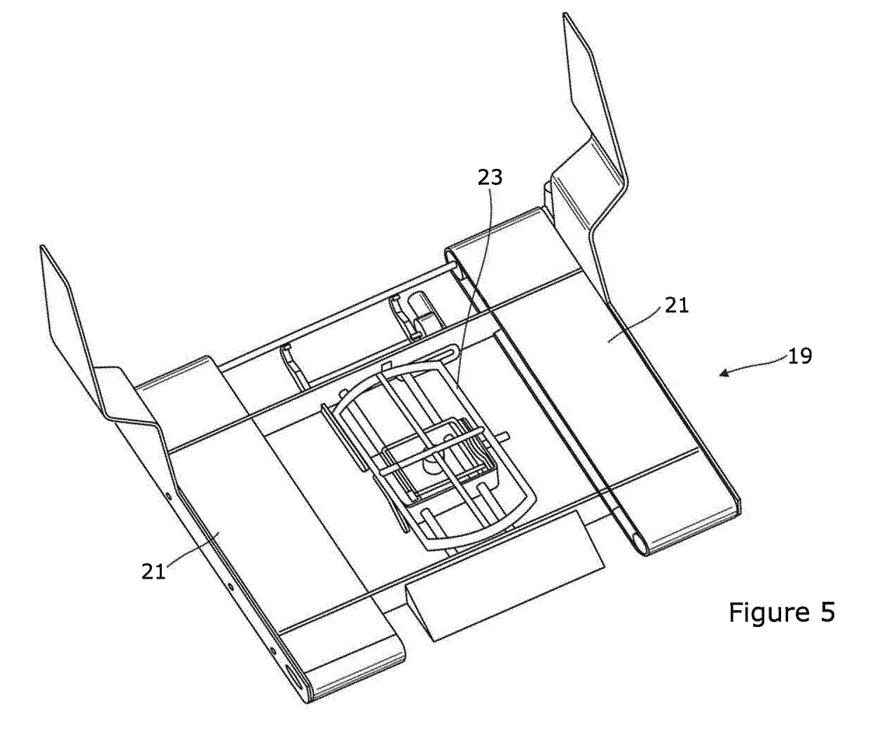

The tower 11 has a frame 17 (FIG. 4) mounted on the guide rails 13 and a platform 19 (FIGS. 5 to 8) movable vertically within the tower frame 17 to and from a lower transfer position for dispensing cones 3 onto the road 5 and for retrieving cones 3 from the road 5.

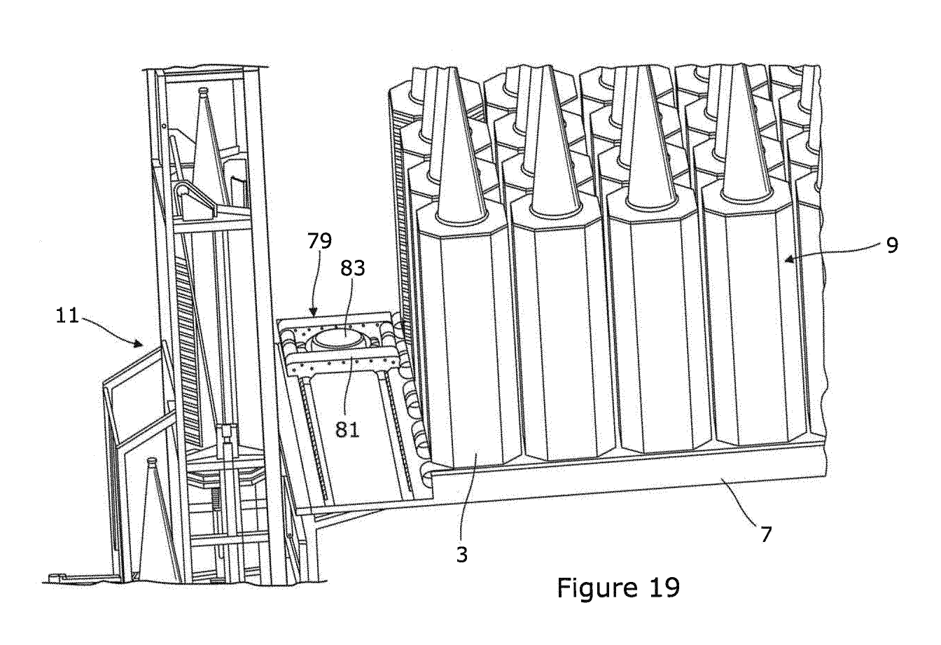

To dispense cones 3, the platform 19 is raised to an upper transfer position spaced above, preferably directly above, the lower transfer position. The tower 11 is positioned to align the platform 19 with the conveyor of a row of stacked cones 3 on the flat bed storage area 7. The conveyor of the aligned row of stacked cones 3 is operated to move the stacks 9 towards the tower 11 and to insert the first stack 9 of cones 3 onto the platform 19. In a modification described in more detail later with reference to FIG. 19, the apparatus includes a device for transferring a stack of cones between the conveyor and the tower.

The platform 19 has a pair of powered belts 21 either side of a central elevator 23. The belts 21 assist movement of the stack 9 of cones 3 onto the platform 19 within the tower 11. The elevator 23 can be raised relative to the powered belts 21 to engage the bottom cone 3 in the stack 9 located on the platform 19 to centre the stack 9 of cones 3 on the platform 19. The elevator 23 can also be raised to lift the stack 9 of cones 3 above the powered belts 21 for a purpose described below.

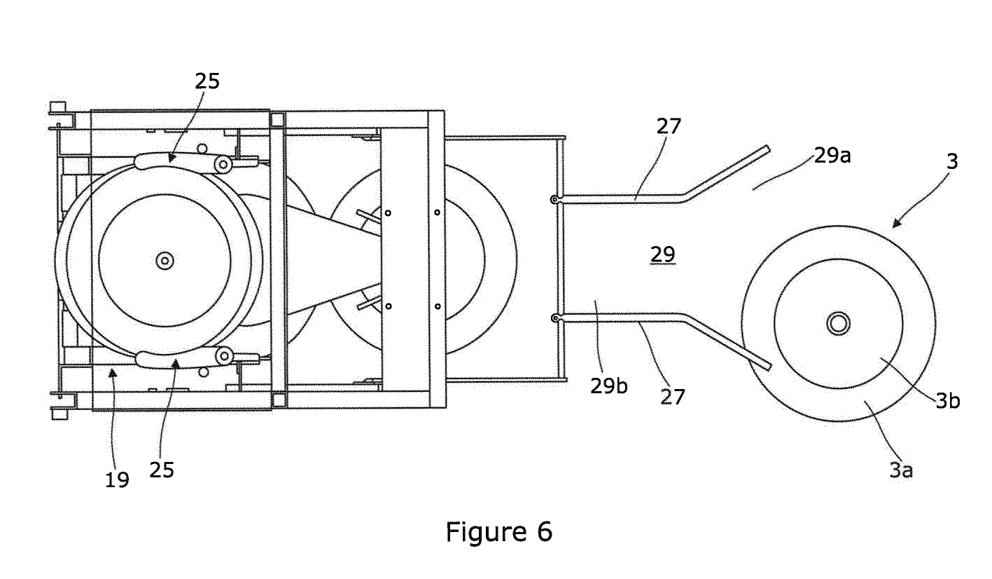

The tower 11 is provided with a plurality of sets of gripping fingers 25 (FIGS. 6 to 9) for holding cones 3 in the stack 9 in an elevated position when the platform 19 is returned to the lower transfer position. The gripping fingers 25 are moveable in unison between open and closed positions. The gripping fingers 25 are moveable from the open position when inserting the stack 9 of cones 3 onto the platform 19 to the closed position to locate under the base 3a of a cone 3 in the stack 9.

The stack 9 of cones 3 is lifted a small distance by the platform, for example 50 mm, to provide clearance for the gripping fingers 25 to move from the open position to the closed position to locate under the base 3a of a cone 3 in the stack. If necessary the elevator 23 is operable to rotate the stack 9 of cones 3 to orientate the bases 3a for engagement with the gripping fingers 25.

The stack 9 of cones 3 is positioned so that, when the gripping fingers 25 move from the open position to the closed position and the stack 9 of cones 3 is lowered, the cone 3 at the bottom of the stack 9 is not supported by the gripping fingers 25.

As a result, the cone 3 at the bottom of the stack 9 is released from the stack 9 and, supported on the platform 19, moves with the platform 19 from the upper transfer position to the lower transfer position, while the remaining cones 3 in the stack 9 are retained in the elevated position at the upper end of the tower 11 by the gripping fingers 25 located under the base 3a of the cones 3.

In the lower transfer position, the powered belts 21 on the sides of the platform 19 are operable to move the cone 3 rearwards from the platform 19 and dispense the cone 3 onto the road.

The platform 19 is then raised to engage the bottom cone 3 of the stack 9 of cones 3 held in the elevated position within the tower 11 by the gripping fingers 25. The stack 9 of cones 3 is then lifted a small distance to allow the gripping fingers 21 holding the cones 3 in the stack 9 to open. The platform 19 is then lowered a distance equal to one cone base so that, when the gripping fingers 25 are moved to the closed position, the cone 3 at the bottom of the stack 9 is not supported by the gripping fingers 25.

As a result, the cone 3 at the bottom of the stack 9 is released from the stack 9 and, supported on the platform 19, moves with the platform 19 from the upper transfer position to the lower transfer position for dispense onto the road as described above while the remaining cones in the stack 9 are held in the elevated position within the tower 11 by the gripping fingers 25. One or more actuators (not shown) may be provided at the base of the stack in the tower that are operable to engage with the cone to be released and force it out of the stack. The above operation is then repeated until all the cones 3 in the stack 9 have been dispensed.

In a modification of the above operation, the platform 19 and gripping fingers 25 can be controlled so that two or more cones 3 can be released from the stack 9 at the same time and dispensed onto the road stacked on top of each other. This may be desirable, for example in windy conditions, to provide additional weight and stability so that the cones 3 stay in position on the road.

When all the cones 3 in the stack 9 have been dispensed, the tower 11 is positioned to receive another stack 9 of cones 3 from the flat bed storage area 7 and the above operation repeated until all the stacks of cones 3 in the flat bed storage area 7 have been transferred to the tower 11 and dispensed or until sufficient cones 3 have been dispensed to demarcate the required section of the road. In a modification described in more detail later with reference to FIG. 19, the apparatus includes a device for transferring a stack of cones between the conveyor and the tower. In this way, the device can receive the next stack of cones to be dispensed from the storage area and move the stack to align with the tower while the tower is dispensing cones from a previous stack of cones. In this way, the tower may not have to be moved to receive the next stack of cones from the storage area so that dispense of cones may continue without interruption.

Where the cones 3 are stacked in rows, transfer of the stacks 9 from the flat bed storage area 7 to the tower 11 may be controlled by the control unit to maintain a balanced load. For example, the tower 11 may receive a stack 9 of cones 3 from each row in turn or any other sequence to maintain a balanced load in the storage area.

To retrieve the cones 3, the vehicle is driven in reverse. Cameras may be provided at the rear of the vehicle and in the driver's cab to assist the driver to position the tower 11 in line with the cones 3 on the road.

Sensors on the tower 11 and/or cone 3 may provide fine adjustment for accurately positioning the tower 11. Any suitable sensors may be employed. Preferably the sensors are capable of operating under all conditions including at night when the volume of traffic using the road is often lower than in the day and it is more convenient to retrieve cones from the road.

The tower 11 may be provided with guide bars 27 that are deployed as the tower 11 approaches the cone 3 to be retrieved. The guide bars 27 define a channel 29 to receive and guide the platform 19 towards the cone 3. The outer ends of the guide bars 27 are angled outwards to provide the channel 29 with a tapered section 29a leading to a narrower parallel section 29b to align the platform 19 with the cone (FIG. 6).

The guide bars 27 are pivotal about a vertical axis at the inner ends such that, if the cone 3 is offset to one side of the parallel section 29b, the cone 3 contacts the angled outer end of the guide bar 27 on that side causing the guide bar 27 to pivot outwards about the inner end against the biasing of a return spring or other restoring force.

This pivotal movement actuates a switch (not shown) that moves the tower 11 to correct the offset until the guide bar 27 no longer presses against the cone 3 and the tower 11 stops leaving the cone 3 aligned with the parallel section 29b central to the platform 19.

In a modification (not shown), one or more sensors may be provided on the tower and/or the cones for detecting the position of a cone and moving the tower to align the platform with the cone. The sensors may be used in place of as well as the guide bars 27. The sensors may be of any suitable type, for example infra-red sensors or laser sensors.

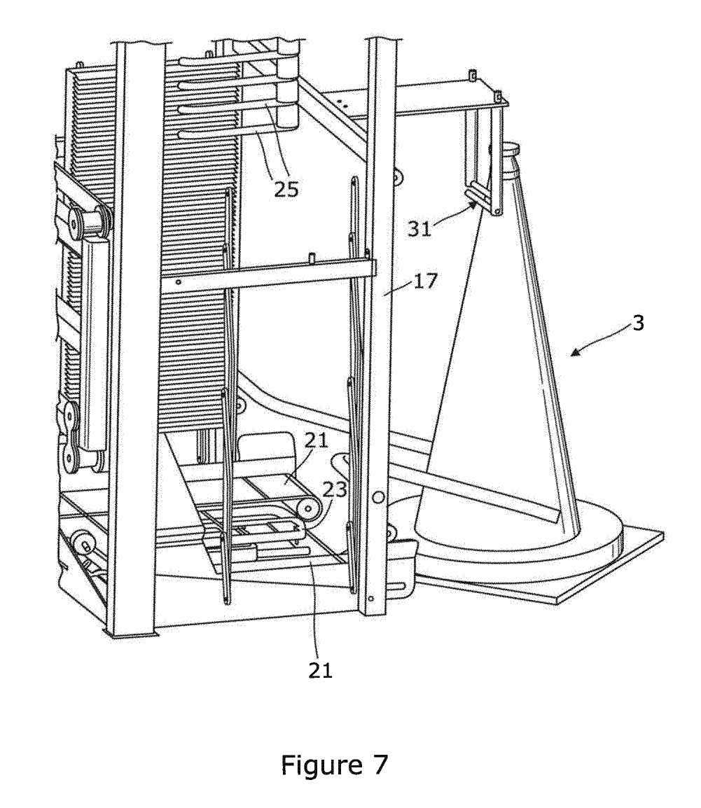

As the platform 19 approaches the cone 3, tilt bars 31 engage the upper end of the cone 3 (FIG. 7 causing the cone 3 to tilt about the base 3a so that the edge of the base 3a nearest to the platform 19 is raised (FIG. 8). Two tilt bars 31 are employed in this embodiment but this is not essential and it may be that one tilt bar may be employed. The or each tilt bar 31 may be provided with a feature which contacts the cone and prevents the cone from twisting or toppling to one side if it is titled onto a corner of the base. For example the or each tilt bar may be provided with a formation co-operable with the cone to locate the cone in a desired orientation for retrieval onto the platform.

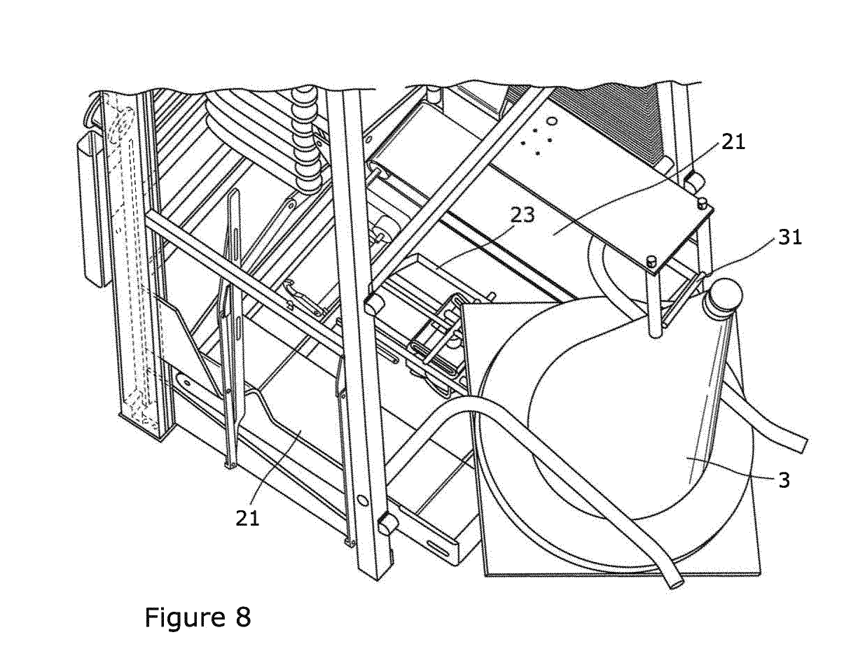

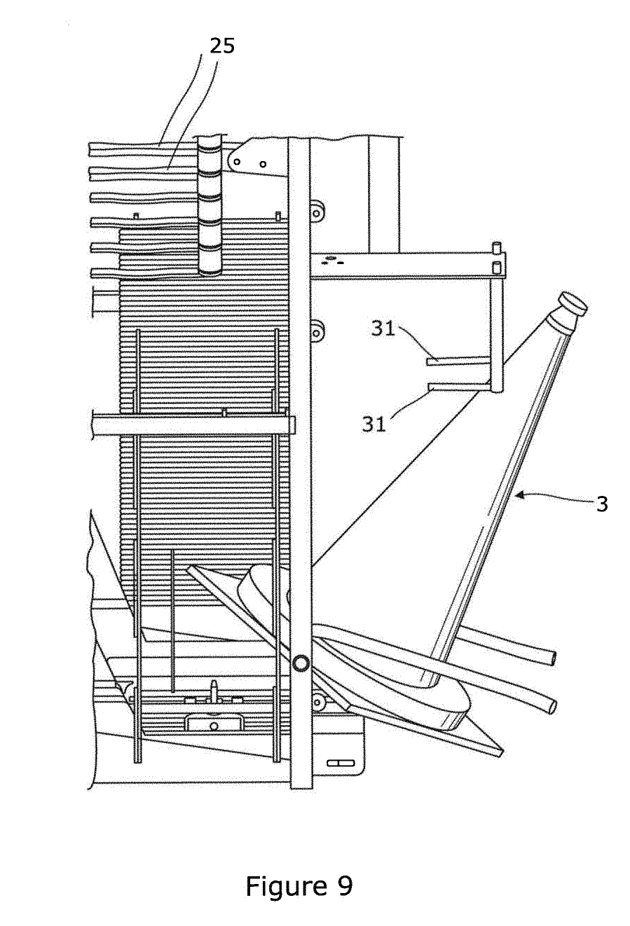

The cone 3 is tilted to an angle relative to the road so that the powered belts 21 at the side of the platform 19 can access beyond the centre of the base 3a of the cone 3 to retrieve the cone 3 and the tilt bars 27 gradually open guiding the cone 3 onto the platform 19 (FIG. 9).

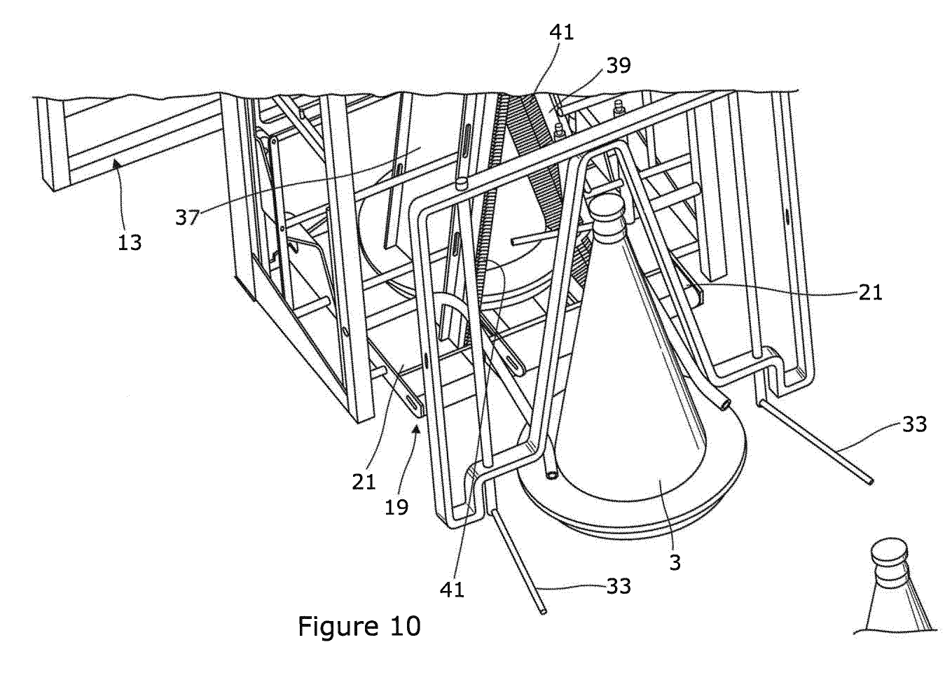

The tilt angle may be approximately 35 degrees although this may change according to the shape and size of the base 3a of the cone 3. As the cone 3 is retrieved, anti-skid bars 33 (FIGS. 10, 11, 12) are deployed to prevent the cone 3 skidding on the road. Two anti-skid bars 33 are employed in this embodiment but this is not essential and it may be that one anti-skid bar may be employed

When the cone 3 has been retrieved from the road onto the platform 19, the elevator 23 may be operable to position the cone 3 centrally on the platform 19 with respect to the gripping fingers 25. For example, the elevator 23 may engage the hole in the base 3a of the cone. The hole and/or part of the elevator 23 received in the hole may taper in towards the top of the base 3a. Tapering the hole in the base of the cone 3 and the part of the elevator 23 received in the hole may better secure the cone 3 to the elevator 23. The elevator 23 may also rotate the cone 3 to orientate the base 3a for engagement with the gripping fingers 25.

The platform 19 is then raised to lift the cone 3 with the gripping fingers 25 closed to position the base 3a of the retrieved cone 3 below the bottom set of gripping fingers 25. The gripping fingers 25 are opened and the cone 3 lifted to position the base 3a of the retrieved cone 3 above the bottom set of gripping fingers 25.

As a result, when the gripping fingers 25 are closed, the retrieved cone 3 is supported on and held in the elevated position by the bottom set of gripping fingers 25 when the platform 19 is lowered to receive the next cone 3 retrieved from the road,

If one or more cones are already supported by the gripping fingers 25 when the platform 19 is raised, the body 3b of the retrieved cone 3 on the platform 19 is received within the body 3b of the cone 3 supported by the bottom set of gripping fingers 25. When the gripping fingers 25 are opened, the stack of cones 3 is lifted one cone base to position the base 3a of the retrieved cone 3 above the bottom set of gripping fingers 25.

As a result, when the gripping fingers 25 are closed, the stack of pones including the retrieved cone 3 is supported on and held in the elevated position by the gripping fingers 25 when the platform 19 is lowered to receive the next cone 3 retrieved from the road. This operation is repeated to reform a stack 9 of cones 3 within the tower 11.

When the last cone 3 to re-form a complete stack 9 of cones 3 is raised on the platform 19, the tower 11 is moved to align with a conveyor on the flat bed storage area 7. The gripping fingers 25 are moved to the open position so that the complete stack 9 of cones 3 is supported on the platform 19. The stack 9 of cones 3 is transferred from the platform 19 to the conveyor with the platform 19 in the upper transfer position level with the conveyor by means of the powered belts 21. In a modification described in more detail later with reference to FIG. 19, the apparatus includes a device for transferring a stack of cones between the conveyor and the tower. In this way, the device can move the stack of cones to be returned to the storage area to align with the conveyor on the storage area while the tower is picking up cones to form the next stack of cones. In this way, the tower may not have to be moved to return the stack of cones to the storage area so that retrieval of cones may continue without interruption.

The conveyor then moves the stack 9 of cones 3 towards the front of the flat bed storage area 7 a distance sufficient to allow another stack 9 of cones 3 to be returned from the tower 11 to re-form the row of stacked cones 3. The return of stacks of cones from the tower 11 to the flat bed storage area 7 may be controlled by the control unit to maintain a balanced load. For example, the stacks 9 of cones 3 may be returned to the rows in turn or any other sequence to maintain a balanced load in the storage area. This operation is repeated until all the cones 3 are recovered.

As will be understood, the above operation to dispense and retrieve the cones 3 is fully automated, does not require any manual lifting of the cones 3 and can be carried out by the driver of the vehicle without any additional operators. It will be appreciated however, that the tower 11 may be employed without the conveyors on the flat bed storage area 7 and that the stacks 9 of cones 3 on the flat bed storage area 7 may be manually inserted into the tower 11 and retrieved from the tower 11.

Referring now to FIGS. 10, 11 and 12, a cone washing device 35 is shown for washing a cone 3 when the cone 3 has been retrieved from the road. Alternatively, or additionally the cone 3 could be washed before it is dispensed onto the road.

The cone washing device 35 includes a pair of panels 37, 39 that are movable to a cleaning position in which the panels 37, 39 close onto a cone 3 located on the platform 19 in the lower transfer position. The elevator 23 is operable to lift and rotate the cone 3 relative to the panels 37, 39. Although two panels are employed in this embodiment, fewer than two panels, i.e. one panel, or more than two panels may be employed.

The surface of the panels 37, 39 contacting the cone 3 is configured, for example with bristles 41 or the like, for cleaning the outer surface of the cone 3 with clean water delivered to one or both panels 37, 39 from a clean water tank (not shown) on the vehicle.

The dirty water from washing the cone 3 may be collected by a drain system placed under the platform 19 and returned to a grey water tank (not shown) on the vehicle. The collected grey water may be filtered and recycled to the clean water tank for use in washing the retrieved cones.

The tower 11 may include a heater unit (not shown) to dry the cones 3 after washing. For example the heater unit may be arranged to dry the cones 3 as they are moved by the platform 19 between the lower transfer position and the upper transfer position. The heater unit may be of any suitable type and may use warm air to dry the cones 3. The heater unit may also be used to warm or dry cones 3 affected by frost or other cold/wet weather conditions.

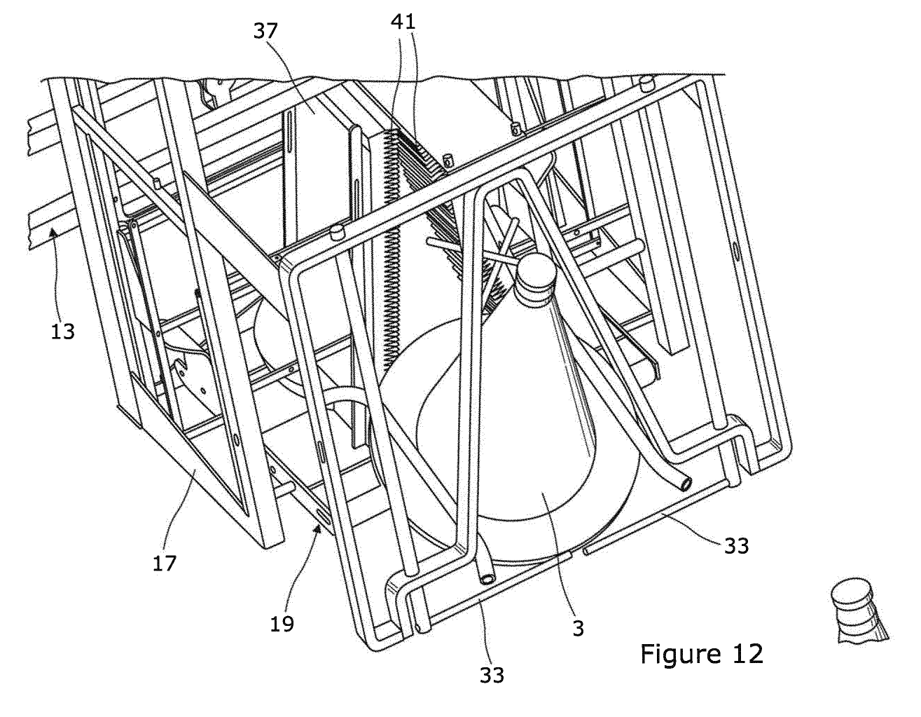

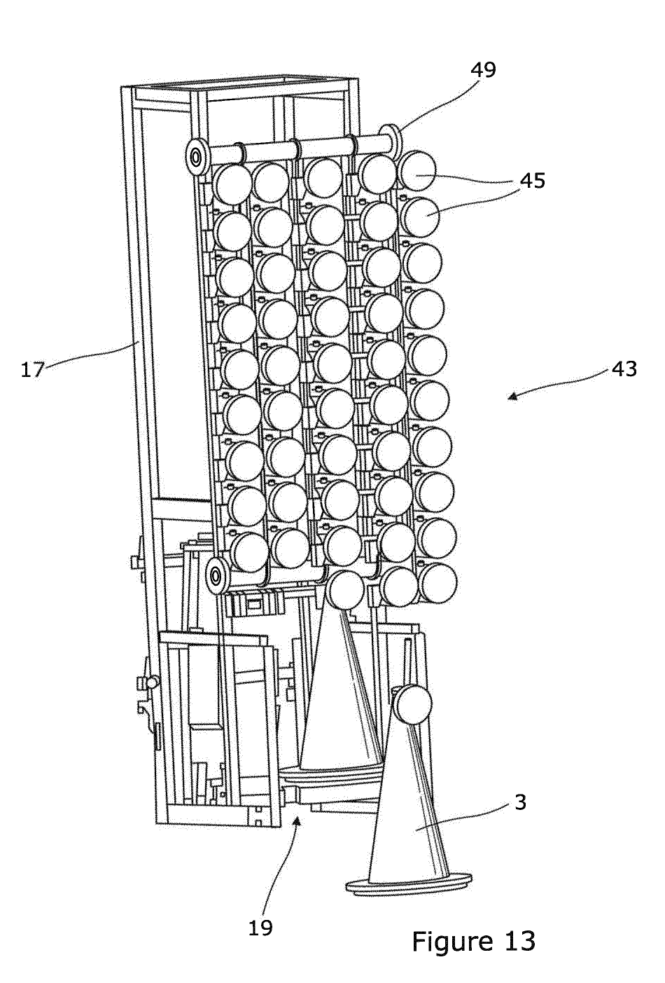

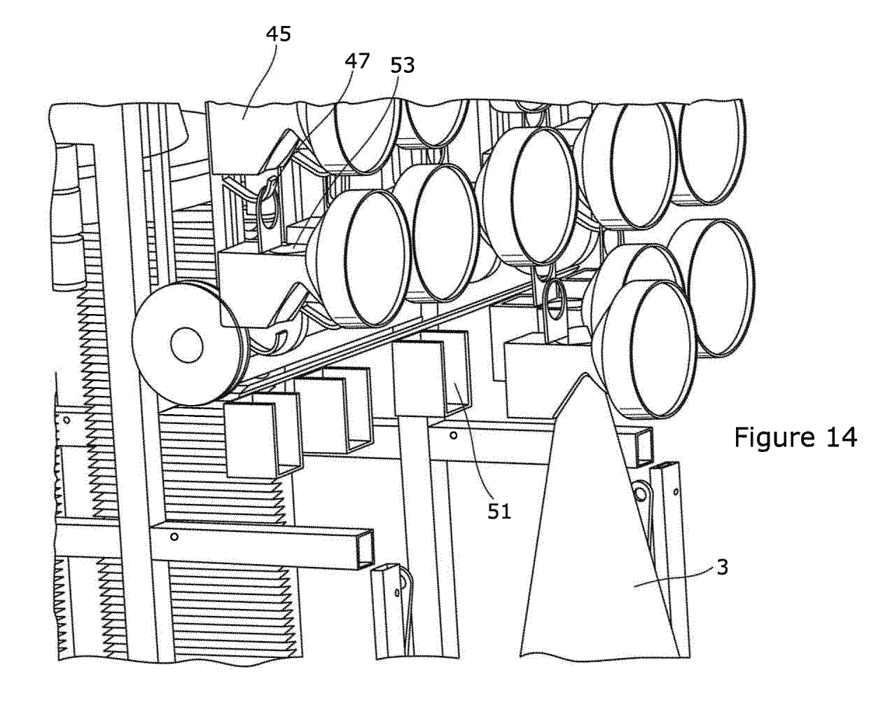

Referring now to FIGS. 13 and 14, a lamp transfer device 43 is shown for fitting a lamp unit 45 to the top of a cone 3 prior to the cone 3 being dispensed onto the road and for removing the lamp unit 45 from the cone 3 when the cone 3 is retrieved from the road.

The lamp units 45 may be battery powered. For example the lamp units 45 may be provided with one or more batteries. The or each battery may be rechargeable. The lamp units 45 may include any suitable light source, for example one or more light emitting diodes (LEDs). The light source may provide white light or coloured light.

The lamp units 45 may have one or more sensors operable to switch the lamp units 45 on and off according to the ambient light levels. Alternatively, the lamp units 45 may be operated on a timer device that may be activated when the lamp unit 45 is fitted to a cone 3 and deactivated when the lamp unit 45 is removed from the cone 3. Any other means for switching the lamp units on and off may be employed.

The light units 45 may be configured for continuous or intermittent illumination. For example the light units 45 may be set to flash on and off. The light units 45 may be set to flash on and off with a fixed or variable time interval. The light units 45 may be set for sequential flashing.

The lamp transfer device 43 is mounted on the front of the frame 17 of the tower 11 and includes a plurality of lamp units 45 mounted on hooks 47 fixed in rows to a powered rotating belt/chain 49 to raise and lower the rows of lamp units 45 according to the direction in which the belt/chain 49 is rotated.

When fitting the lamp units 45 to cones 3 being dispensed onto the road, the rows of lamp units 45 rotate down one row and one of the lamp units 45 in the bottom row drops into a holder 51 positioned to receive the lamp unit 45 and the lamp unit 45 is released from the hook 47.

In this embodiment the holder 51 is a box open at the front in which the lamp unit 45 is located and retained in place. The holder 51 is movable from side to side to position the lamp unit 45 in a central position with respect to the platform 19.

When a cone 3 arrives at the lower transfer position on the platform 19, it is moved to align the top of the cone 3 with a hole 53 in the lamp unit 45 at the central position and the elevator 23 raises the cone 3 to insert the top of the cone 3 into the hole 53 (FIG. 14) and attach the lamp unit 45 to the cone 3.

As a result, when the cone 3 is moved forwards by the platform 19, the lamp unit 45 moves out of the holder 51 and the cone 3 with the lamp unit 45 attached is dispensed onto the road.

The rows of lamp units 45 rotate up one row and the holder 51 is positioned below a lamp unit 45 in the bottom row and the rows of lamp units 45 are rotated down one row to transfer the lamp unit 45 to the holder 51. The holder 51 then positions the lamp unit 45 in the central position for transfer to another cone 3.

This operation is repeated until all the lamp units in one row have been transferred to cones 3 and the rows of lamp units 45 are rotated to lower the next row for transfer to the cones 3. In this embodiment, each row is shown having five lamp units 45 but it will be understood that there may be more than or less than five lamp units 45 in each row.

Lamp units 45 may be attached to each cone 3 to be dispensed onto the road. Alternatively, lamp units 45 may be attached to only some of the cones 3 to be dispensed on the road, for example where the number of cones 3 to be dispensed exceeds the available number of lamp units 45, some cones may be dispensed without lamp units 45.

It may be that the platform 19 can be controlled via the control unit to attach a lamp unit 45 to the cone 3 to be dispensed. The control unit may be programmable to operate the platform 19 to attach a lamp unit 45 to every other cone 3 or at some other interval as desired. Alternatively or additionally, the user interface may allow an operator to select the cones 3 to which lamp units 45 are to be attached as the cones 3 are being dispensed.

When a cone 3 having a lamp unit 45 attached is retrieved from the road, the holder 51 is located at the centre position. Sensors identify the orientation of the lamp unit 45 relative to the holder 51 and, if necessary, the elevator 23 rotates the cone 3 to bring the lamp unit 45 into line with the holder 51. The sensors can also be used to rotate the cone/lamp unit to a preset direction when setting it.

The cone 3 with the lamp unit 45 attached is raised by the elevator 23 and may be rotated to position the lamp unit 45 for reception in the holder 51. The cone 3 is then lowered to disengage the top of the cone 3 from the hole 53 in the lamp unit 45 which is held in the holder 51.

The holder 51 is positioned to transfer the lamp unit 45 to a hook 47 and the lamp unit 45 lifted out of the holder 51 when the rows of lamp units 45 rotate up one row. The holder 51 is then moved to receive and transfer another lamp unit 45 from a cone 3 to a hook 47 and the process repeated to recover all the lamp units 45.

The lamp units 45 may be washed when they are recovered and/or when they are dispensed. For example one or more water jets may be arranged to wash a lamp unit 45 received in the holder 51.

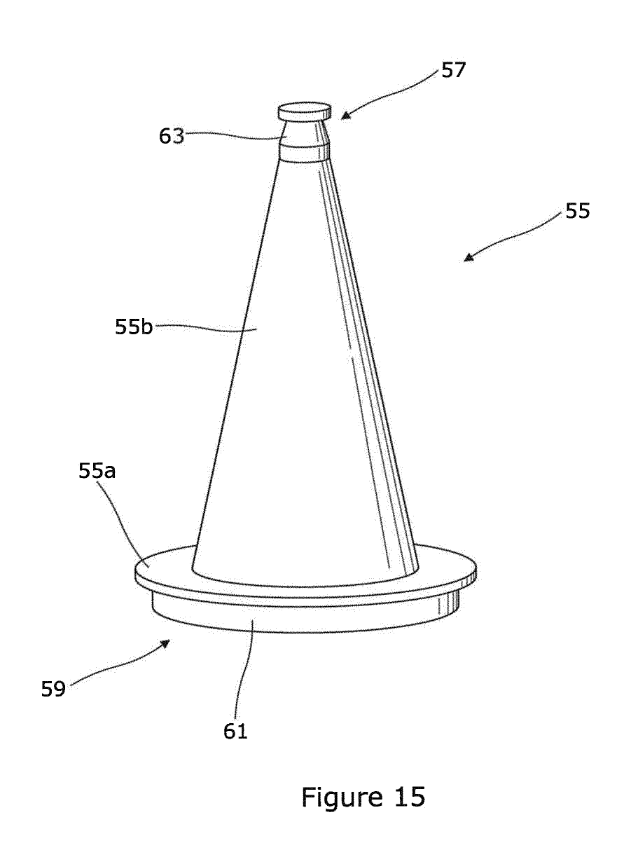

Referring now to FIG. 15, a cone 55 suitable for use with the apparatus above-described is shown with a light unit 57.

The cone 55 has a base 55a and a conical-shaped body 55b that is hollow and can be accessed through a central hole in the base 55a. The hole may taper in towards the top of the base. The base 55a may be circular or substantially circular in plan view. In use with the apparatus described above, the elevator 23 of the platform 19 is engageable within the hole to centre and/or rotate the cone 55 on the platform 19 as described previously.

The base 55a is provided on the underside with a spacer formation 59. In this embodiment, the formation 59 is formed by an annular wall 61 inset from the perimeter of the base 55a. The spacer formation 61 may be formed integrally with the base, for example one moulded part. In a modification (not shown), the wall 61 may be replaced by a plurality of spacer formations located at intervals around the underside of the base and inset from the perimeter.

When cones 55 are stacked one on top of another, the spacer formation 59 provides a gap between the bases 55a. In use with the apparatus described above, the gap provides access when the gripping fingers 25 are closed to support the cones 55 in the elevated position within the tower 11 as described previously. The cone 55 may be symmetrical about a vertical axis through the light unit 57. As a result, it may not be necessary to rotate the cone 55 to align the base 55a with the gripping fingers 25. In other embodiments, the cone may be asymmetrical about the vertical axis.

The spacer formation 59 may also reduce the contact points/area between the bases 55a of the cones in the stack. As a result, the effect of frost etc sticking the bases 55a together may be reduced allowing the cones to be separated from the stack as described previously

The light unit 57 has a housing 63 at the apex of the body 55b and a light module (not shown) located inside the housing 63. The light module may be detachable from the housing 63 for repair and/or replacement. The housing 63 may be made of a light transmitting material. For example the housing 63 may be made of transparent or translucent plastics.

The housing 63 may be formed integrally with the cone 55, for example one moulded part. Alternatively, the housing 63 may be formed separately from the cone 55 and attached to the cone 55 by any suitable means, for example a push-fit or snap-fit in a hole at the apex of the body 55. Where the housing 63 is attached to the cone 3 it may be detachable for removing the light unit 57 for repair and/or replacement.

The light module may comprise any suitable light source, for example one or more light emitting diodes (LEDs). The light source may provide white light or coloured light. The light module may be battery powered. For example the light unit 57 may be provided with one or more batteries. The battery may be rechargeable.

The light units 57 may be configured so as to be interconnected when the cones 55 are stacked one on top of the other such that the batteries of the light units 57 in the stack can be connected to a common power source to re-charge the batteries while the cones 55 are stacked on a vehicle or while in storage. Charging may be effected via a manifold (not shown) attached to one or more stacks of cones 55. The manifold may be attached to the top cone 55 in the stack.

The light units 57 may have one or more sensors operable to switch the light units 57 on and off according to the ambient light levels. Alternatively, the light units 57 may be operated on a timer device that may be activated when the cone 3 is dispensed onto the road and deactivated when the cone 3 is retrieved from the road. Any other means for switching the light units 57 on and off may be employed.

The light units 57 may be configured for continuous or intermittent illumination. For example the light units 57 may be set to flash on and off. The light units 57 may be set to flash on and off with a fixed or variable time interval. The light units 57 may be set for sequential flashing.

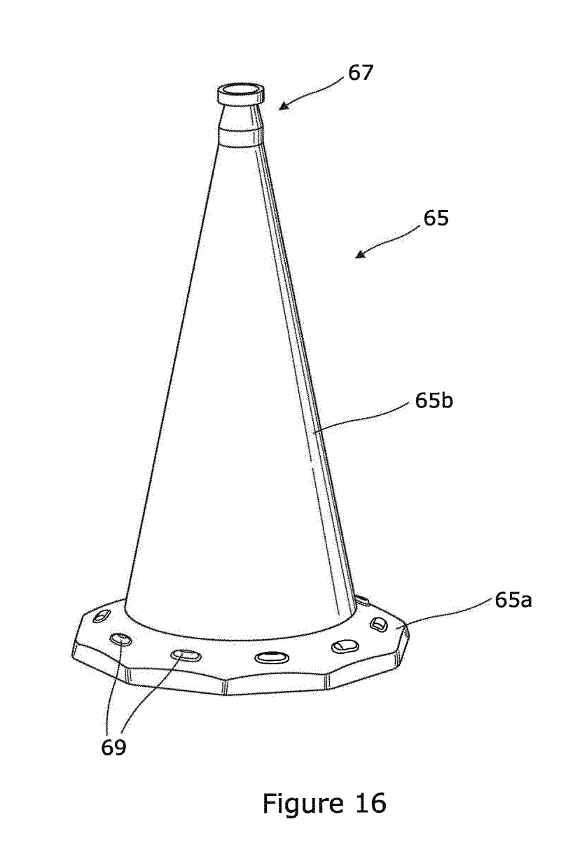

Referring now to FIG. 16, another cone 65 suitable for use with the apparatus above-described is shown with a light unit 67 at the apex of the body 65b. The light unit 67 is similar to the light unit 57 of the cone 55 described above with reference to FIG. 15 and the description of the light unit 57 applies to the light unit 67.

The cone 65 has a base 65a and a conical-shaped body 65b that is hollow and can be accessed through a central hole in the base 65a. The hole may taper in towards the top of the base 65a. The base 65a is generally annular in plan view. The upper surface of the base 65a may taper from the body 65b to the outer edge of the base 65a. The draft angle may be 5 to 15 degrees, preferably approximately 11 degrees. The peripheral edge of the base 65a may be circular or polygonal with flats. In use with the apparatus described above, the elevator 23 of the platform 19 is engageable within the hole to centre and/or rotate the cone 65 on the platform 19 as described previously.

The base 65a is provided on the upper surface with a plurality of spacer formations 69 projecting from the upper surface of the base 65a. In this embodiment the spacer formations are provided by a series of ribs located at intervals around the upper surface of the base 65a and inset from the perimeter of the base 65a. The spacer formations 69 may be formed integrally with the cone 65, for example one moulded part.

Any number of spacer formations 69 may be provided. The spacer formations 69 may be of any size or shape and may be provided at any position inset from the perimeter of the base. In a modification (not shown) the spacer formations may be replaced by one formation that extends around the upper surface of the base and is inset from the perimeter of the base.

When cones 65 are stacked one on top of another, the spacer formations 69 engage the underside of the base 65a of the cone above so that the bases 65a of the cones in the stack are separated providing a gap between the bases 65a. In use with the apparatus described above, the gap provides access for the gripping fingers 25 to support the cones 65 in the elevated position within the tower 11 as described previously. The cone 65 may be symmetrical about a vertical axis through the light unit 67. As a result, it may not be necessary to rotate the cone 65 to align the base 65a with the gripping fingers 25. In other embodiments, the cone may be asymmetrical about the vertical axis.

The spacer formations 69 also reduce the contact points/area between the bases 65a of the cones in the stack. As a result, the effect of frost etc sticking the bases 65a together may be reduced allowing the cones to be separated from the stack as described previously.

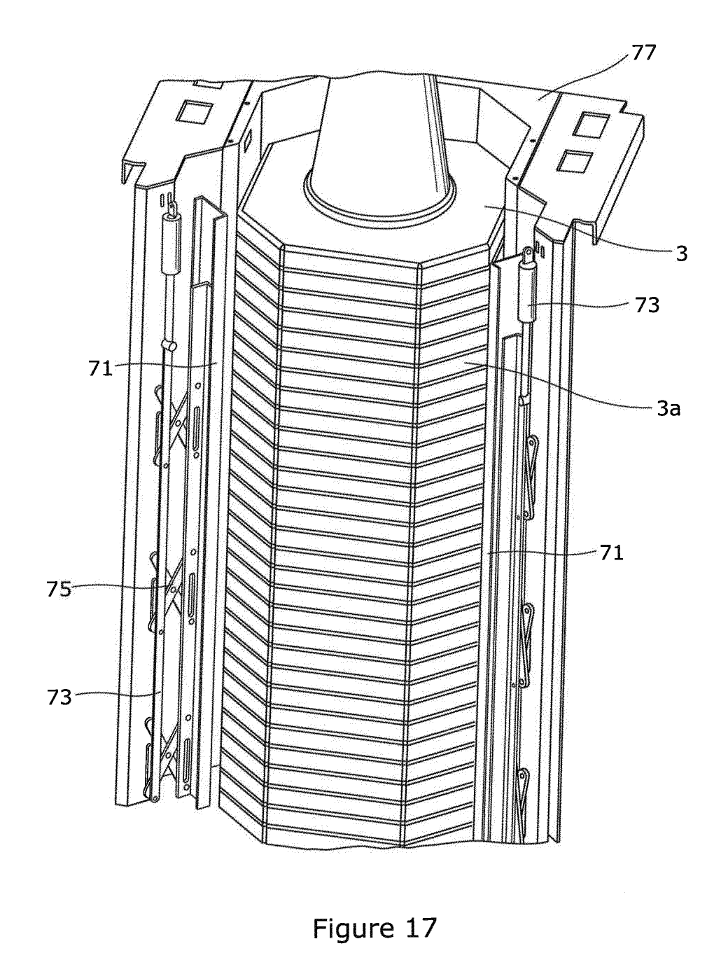

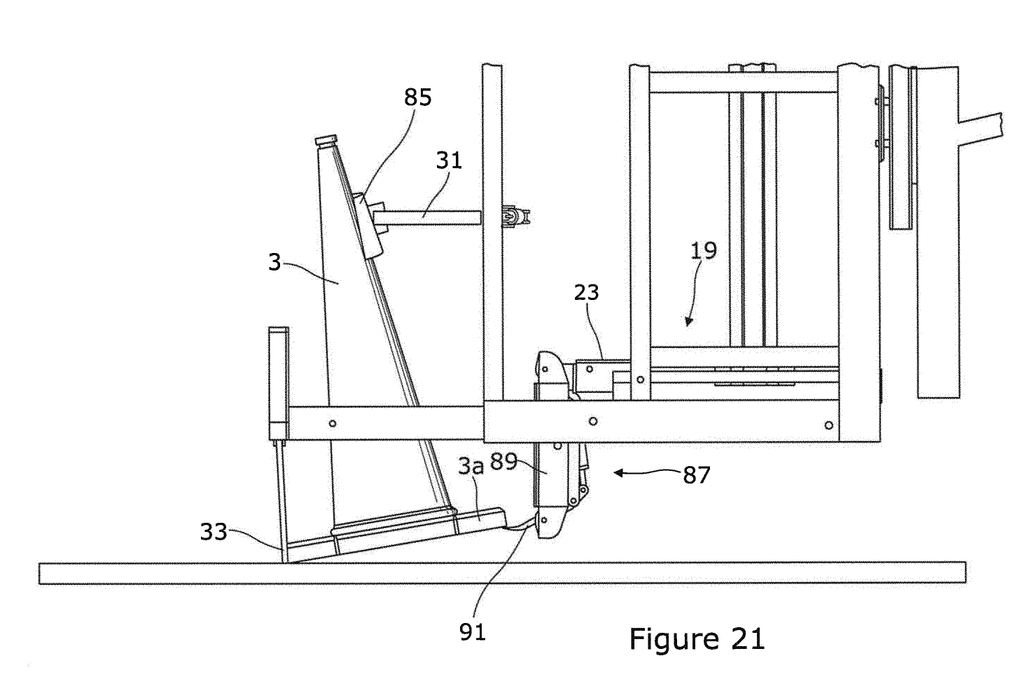

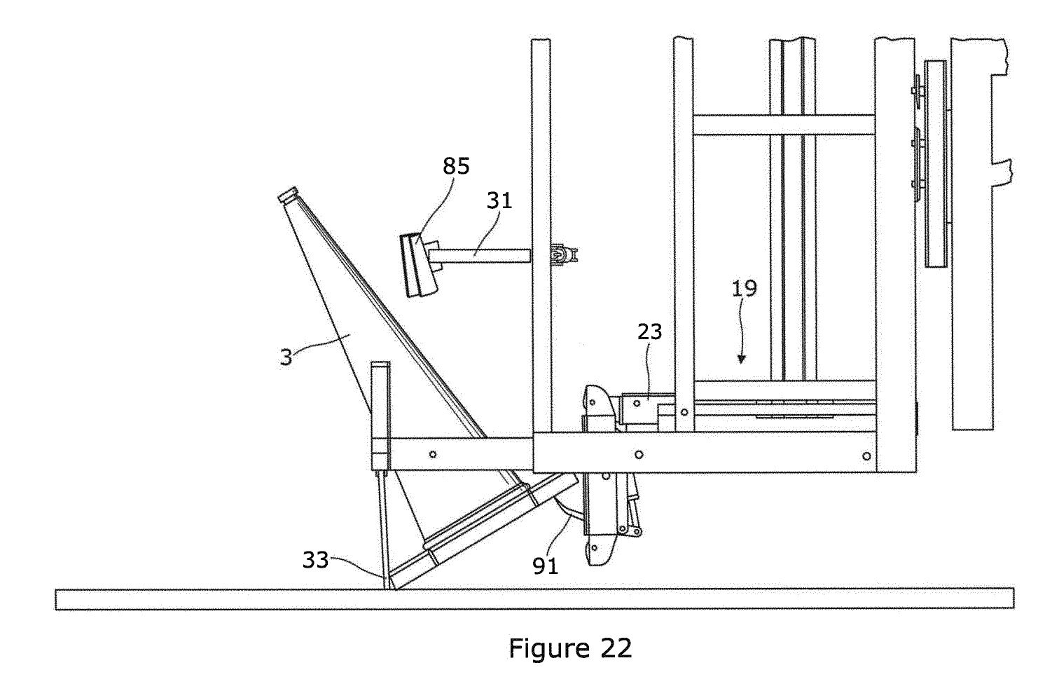

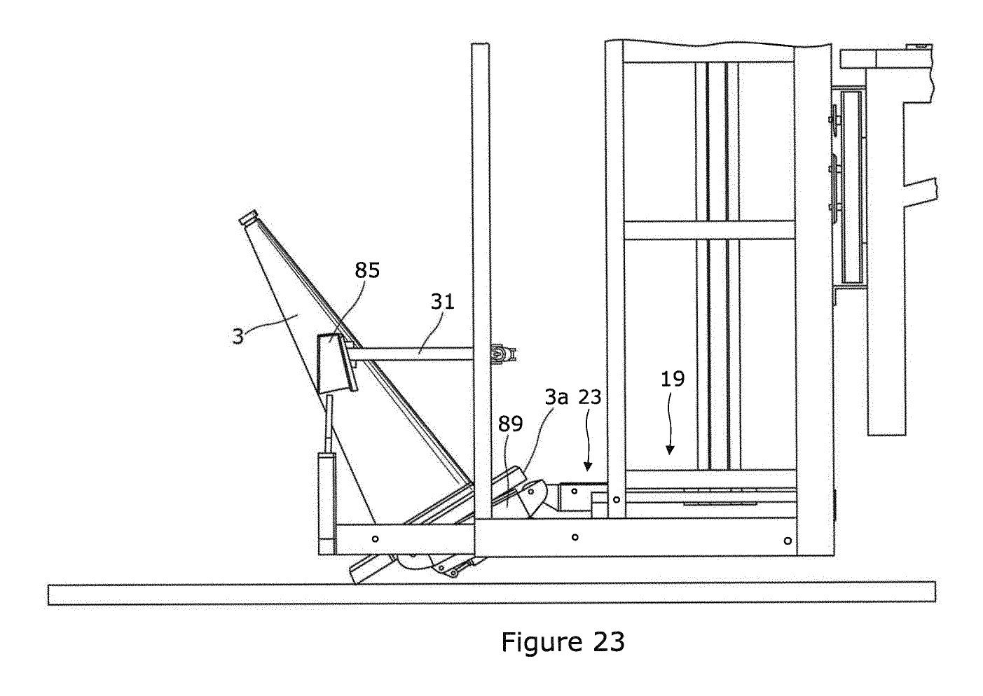

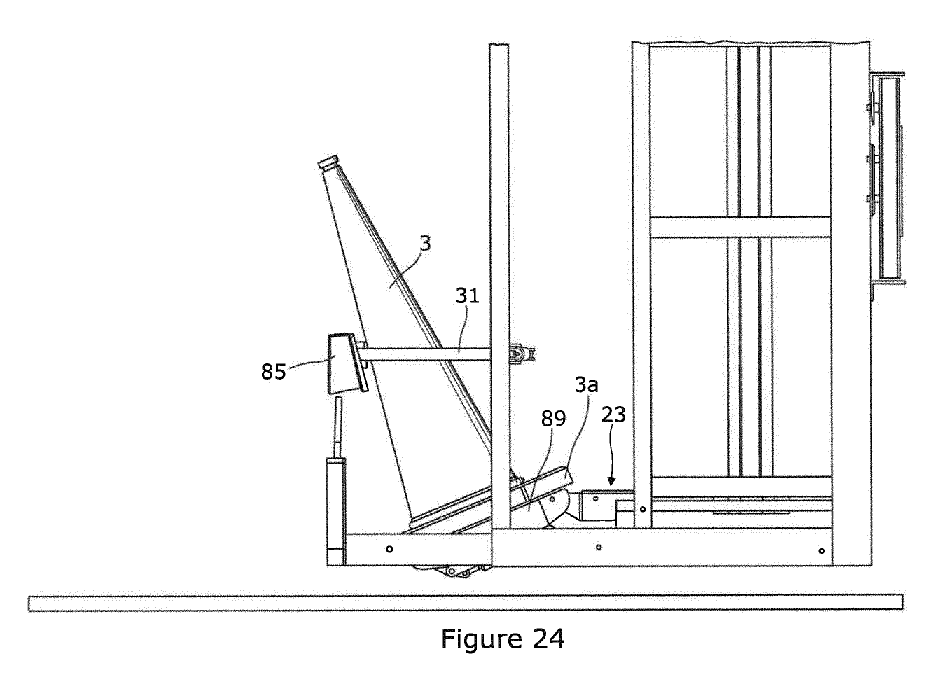

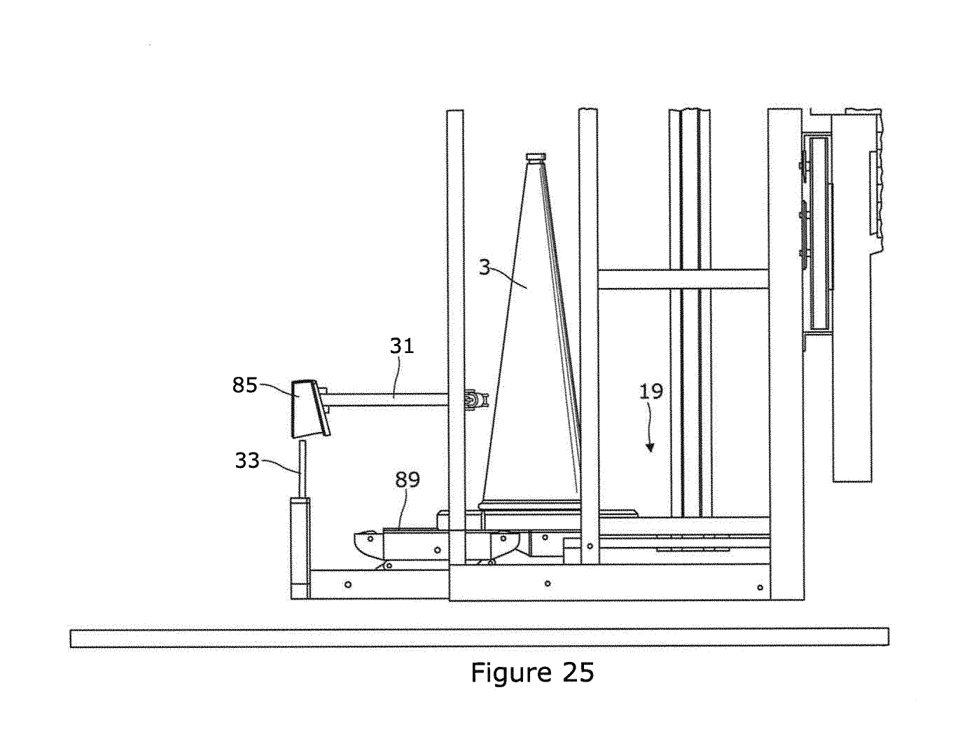

The invention is not limited to the embodiments above-described. Various modifications are shown in FIGS. 17 to 40. For convenience, like reference numerals are used for the same or similar parts and the arrangement and operation of such parts is the same as previous embodiments unless indicated to the contrary and is only repeated so far as necessary for an understanding of the modifications and the previous embodiments should be referred to for a more detailed description of such parts.

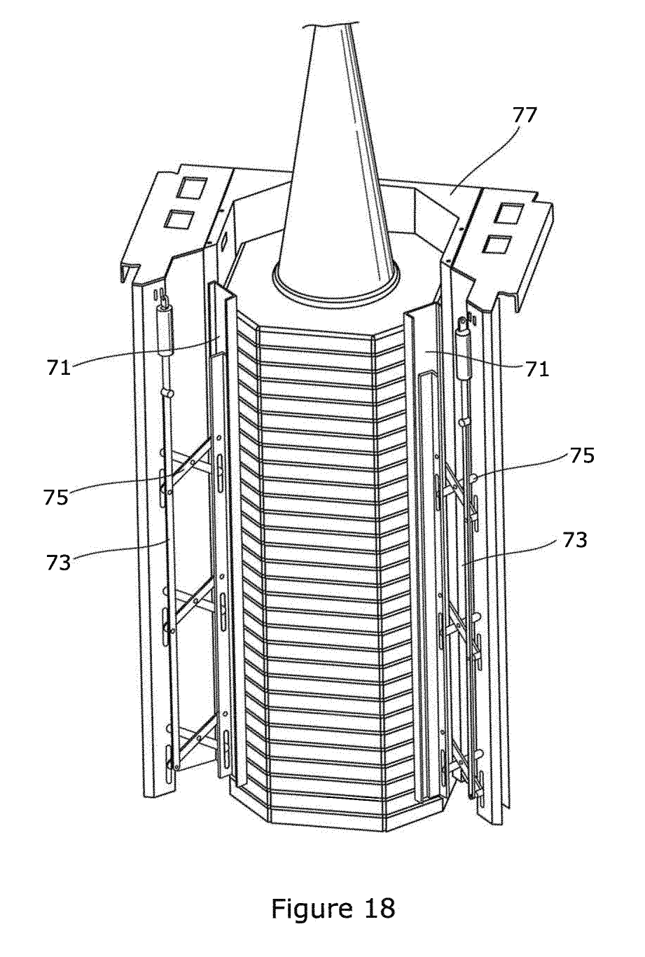

Referring to FIGS. 17 and 18, the gripping fingers 25 for holding cones 3 in an elevated position may be replaced by a set of clamping bars 71 movable between an open position and a closed position for engaging the base 3a of a cone 3 located between the clamping bars 71. In this embodiment there are two clamping bars but this is not limiting and the number of clamping bars may be altered, for example one or more clamping bars may be employed. The clamping bars 71 may be operated by any suitable means such as powered rains 73 and scissor linkages 75. To dispense cones 3, the platform 19 is moved to the upper transfer position to receive a stack of cones 3 from the flat bed storage area 7 (or a device for transferring stacks of cones between the flat bed storage area and the tower such as described later with reference to FIG. 19) with the clamping bars 71 in the open position (FIG. 17). The platform 19 then lowers the stack of cones a distance equal to the thickness of the base 3a of the cone 3 at the bottom of the stack (or multiples thereof if more than one cone is to be lowered by the platform 10) with the clamping bars 71 in the open position. The clamping bars 71 are then moved inwards to the closed position to engage the bases 3a of the other cones 3 in the stack that are held in a sleeve 77 in the elevated position when the platform 19 is moved to the lower transfer position with the bottom cone (or cones) from the stack for dispense onto the road as described previously. The platform 19 is then moved to the upper transfer position and the clamping bars 71 moved to the open position to release the stack of cones. The platform 19 is then lowered to move the bottom cone (or cones) below the clamping bars 71 and the clamping bars 71 moved to the closed position to engage the bases 3a of the other cones 3 in the stack and the platform 19 moved to the lower transfer position to dispense the bottom cone (or cones) onto the road as described previously. The above operation is repeated until all the cones in the stack have been dispensed. The platform 19 can then receive another stack of cones from the storage area 7. To retrieve cones, the platform 19 is arranged in the lower transfer position for transfer of a cone (or cones) from the road onto the platform as described previously. The platform is then moved to the upper transfer position. The clamping bars 71 are then opened and the platform 19 is raised to position the base of the retrieved cone (or cones) between the clamping bars 71. The clamping bars 71 are then moved to the closed position to grip the base 3a of the cone 3 (or cones) and the platform moved to the lower transfer position to receive the next cone from the road. The above operation is repeated until a stack of cones has been reformed. The stack of cones can then be returned to the storage area 7. Dispensing and retrieving of the cones may be combined with fitting/removing lamps on the cones and/or washing the cones as described previously. As will be appreciated, the clamping bars 71 engage the edge of the cone base 3 to hold the cone in the elevated position and the bases of the cones in a stack of cones therefore do not have to be spaced apart. The clamping arrangement may be used with cones having spacers to separate the bases in a stack of cones and with cones without any spacers to separate the bases in a stack of cones.

Referring now to FIG. 19, the flat bed storage area 7 may be provided with a device for moving cones between the tower and the storage area. In this embodiment, a shuttle 79 is provided at the rear end of the storage area 7. The shuttle 79 is movable from one side of the storage area 7 to the other side. When dispensing cones onto the road from the tower, the shuttle 79 can be positioned to align with the conveyor of any of the rows of stacked cones on the storage area. The conveyor is then operated to transfer one stack of cones to the shuttle 79. The shuttle 79 can then be moved to wherever the tower is dispensing cones to transfer the stack of cones to the tower without interrupting the dispensing operation. Similarly, when retrieving cones from the road into the tower 11, the shuttle 79 can be moved to wherever the tower is retrieving cones and transfer a stack of cones from the tower 11 back to the flat bed storage area 7 without interrupting the retrieving operation. Sensors (not shown) may be provided to align the shuttle 79 with the tower and conveyors. The shuttle 79 may have a conveyor 81 for transferring stacks of cones between the storage area 7 and the tower 11. The shuttle 79 may have a turntable 83 for rotating the stack of cones to the required orientation for transfer between the storage area 7 and the tower 11. The shuttle 79 may be used when loading/unloading the flat bed storage area 7. For example, when loading the flat bed storage area 7, the shuttle 79 may be positioned to receive a stack of cones to be loaded onto the flat bed storage area 7 and deliver the stack to the appropriate conveyor on the flat bed storage area 7. Similarly when unloading the flat bed storage area 7, the shuttle 79 may be positioned to receive a stack of cones from any of the conveyors on the flat bead storage area 7 and deliver the stack for unloading from the flat bed storage area 7. Loading/unloading may be provided by any suitable means such as a forklift truck.

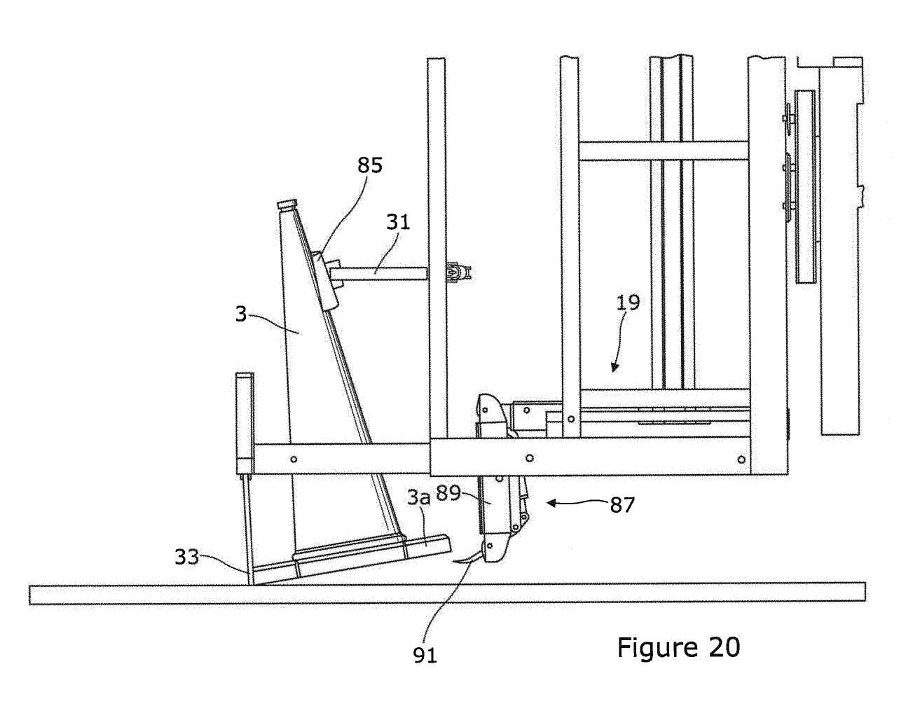

Referring to FIGS. 20 to 25, the tilt bars 31 may be provided with features 85 that engage the upper part of a cone 3 and inhibit or prevent the cone 3 twisting or toppling to one side when it is tilted during the retrieval operation. For example feature 85 may be a cone shaped part or any other suitably shaped part. The platform 19 may be provided with a device 87 for assisting retrieval of a cone 3 from the road. The device 87 may include a conveyor section 89 and one or more levers 91 arranged to move under the cone 3 when it is tilted by the tilt arms 31 during the retrieval operation. The levers 91 rotate up and back towards the elevator 23, further tilting the cone 3, drawing it back and keeping it stabilised. This movement counters the movement of the reversing truck and reduces the tilting pressure on the top section of the cone 3 during the initial tilt and also assists the antiskid bars 33 in preventing the cone 3 from skidding on the road. The conveyor 89 also rotates up and assists the smooth transfer of the cone 3 onto the elevator. The conveyor 89 preferably aligns with the elevator 23 to transfer the cone 3 onto the elevator 23.

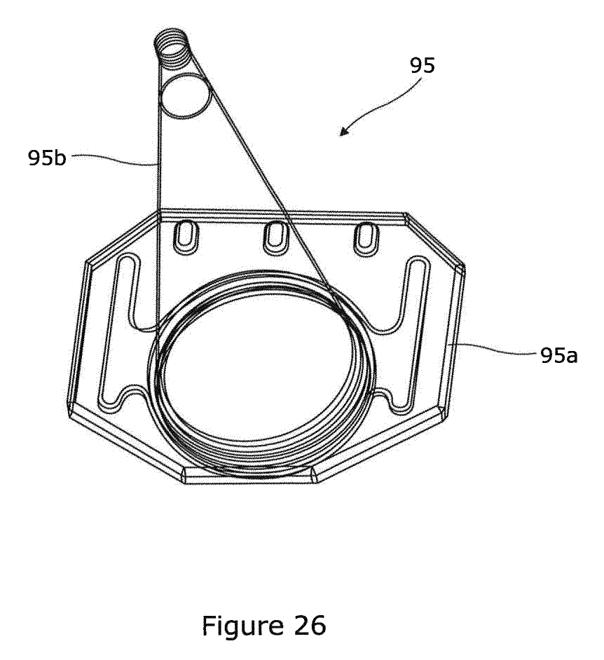

Referring now to FIG. 26, another cone 95 is shown. The cone 95 has a base 95a and a conical-shaped body 95b that is hollow and can be accessed through a central hole in the base 95a. The hole may taper in towards the top of the base 95a. The base 95a is generally rectangular in plan view with angled corners although the base 95a may have other shapes. The base 95a is offset relative to a vertical axis through the body 95b. The base 95a protrudes from the body 95b on three sides. Preferably one side of the base 95a protrudes from the body 95b to a greater extent than the opposed side. The opposed side may not protrude from the body 95b to any appreciable extent. When setting the cone 95 down onto the road, for example to close off a lane, the offset cone base 95a can be placed on the road with protruding side of the base 95a facing in towards the closed lane and the opposed side facing out towards the live lane. As a result, the possibility of the base 95a being driven over by passing traffic in the live lane is reduced compared to a regular based cone where the base protrudes on all side of the body and is not in the drivers line of vision, leaving the side facing towards the live lane prone to being driven over so that the cone is moved or knocked over. The cone may be used with the apparatus described herein which can set the cone down in the required orientation. The cone may include any of the features of any other embodiments.

The device 87 of FIGS. 20 to 25 assists the dispensing and retrieval of the cones, but it does not move independently of the platform 19. FIGS. 27 to 40 show an embodiment where a first platform moves cones to and from the tower, while a second platform takes cones from the first platform to dispense onto the road and retrieves cones from the road to put them onto the first platform. This reduces the time taken by splitting the movement of the cones between the two platforms, rather than having one platform to perform all the movements.

FIGS. 27 to 40 also show an assembly to move the cones between the tower and the vehicle independently of the first platform, which also reduces the time taken in dispensing and retrieving the cones, as the platform does not need to transfer the cones between the tower and the vehicle as well as dispensing and retrieving them.

Further, FIGS. 27 to 40 also show a securing mechanism to ensure that a cone is held securely on the platform, whether it is being dispensed or retrieved. It also ensures that a cone can be removed from the base of a stack of cones for dispensing in a timely manner, even if it is not freely movable.

As shown in FIG. 27, the tower 11 has a frame 17 with an L-shaped profile mounted on the guide rails 13. First and second platforms 19, 20 are mounted in the frame 17 for movement in dispensing cones 3 onto the road or retrieving cones from the road. The first platform 19 is movable vertically within the longer upright arm 101 of the tower frame 17 to and from a first lower transfer position 103 to move individual cones 3 up and down in the tower 11 for dispensing and retrieving the cones 3. The first platform 19 is shown in FIG. 27 in an upper transfer position 105 and can adopt positions in between those positions as desired.

FIGS. 28 and 29 show the first platform 19 in more detail, having a frame for mounting a pair of powered belts 21, one on each side of a central turntable 23. The turntable 23 is mounted on a scissor lift 107 and can therefore be lifted from the position shown in FIG. 28 where it is substantially level with the belts 21 to a raised position of FIG. 29. The turntable 23 has a peripheral raised edge 109 spaced from a central frusto-conical portion 111, in which are mounted radially extendable cone grippers 113. As shown there are four grippers, in a retracted position in FIG. 28 and an extended position in FIG. 29. The arrangement allows a cone 3 to be secured to the first platform 19, with the frusto-conical portion 111 in the hollow centre of the cone, the base retained between the peripheral edge 109 and the frusto-conical portion 111, and the grippers 113 extended radially outwardly to contact the internal surface of the cone. The grippers 113 form a securing mechanism for the cone 3.

The second platform 20 is mounted in the base of the tower 11, in the shorter arm 115 of the frame 17. The second platform 20 is mounted on a first side 117 of the frame 17 by an arm 119 for movement from a lower position 121 shown in FIG. 27, to an upper position 123. The arm 119 is mounted on the frame 17 for movement between an outer position shown in FIG. 27 and an inner retracted position (see FIG. 33). The second platform also has powered belts 125.

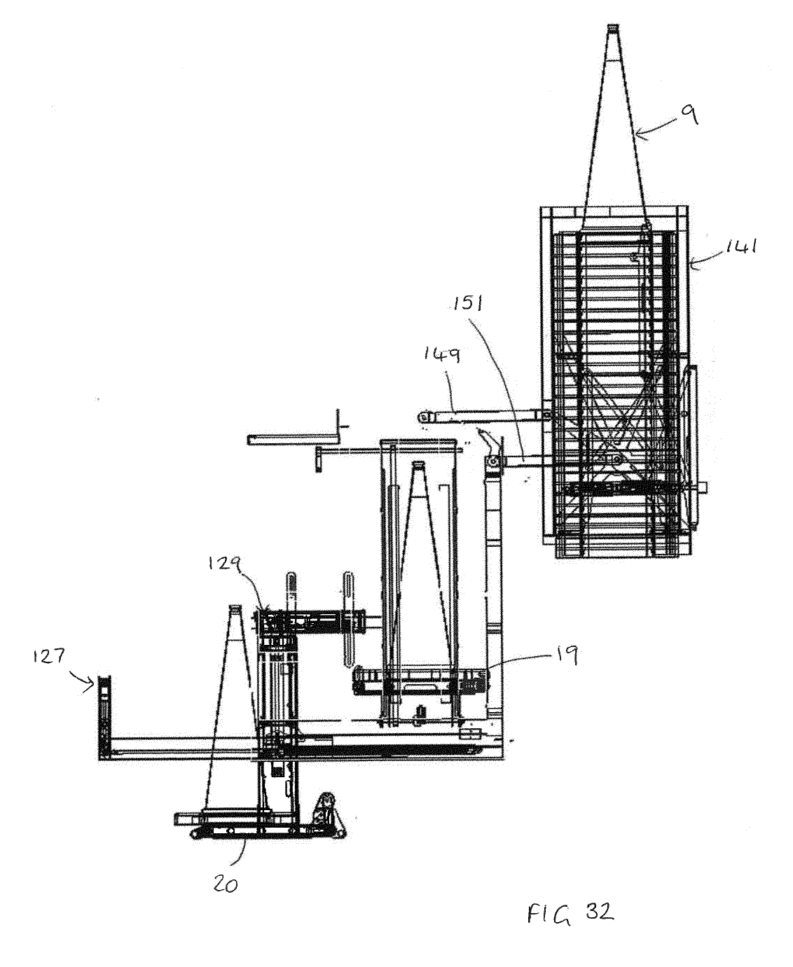

The shorter arm 115 of the frame 17 also mounts an anti-skid assembly 127 and a toppler assembly 129. The anti-skid assembly 127 comprises a slider 131 mounted on a second side 133 of the frame 17 for outward and inward movement. An arm 135 is mounted on the outer end of the slider 131 to pivot between a retracted position shown in FIG. 27 and an operative position (see FIG. 35).

The topple assembly 129 is also mounted on the second side of the frame 17. As best seen in FIGS. 33 and 34, it comprises a part-conical toppler collar 137 pivotally mounted on an arm 139 which can swing between a retracted position adjacent the frame 17 in FIG. 33 and the operative position shown in FIG. 34.

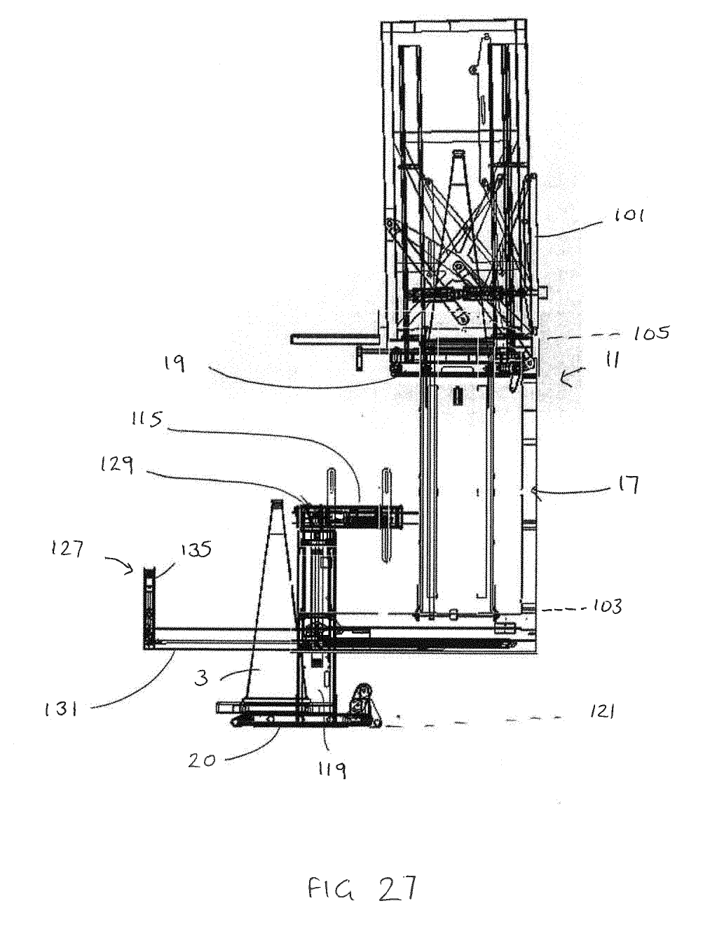

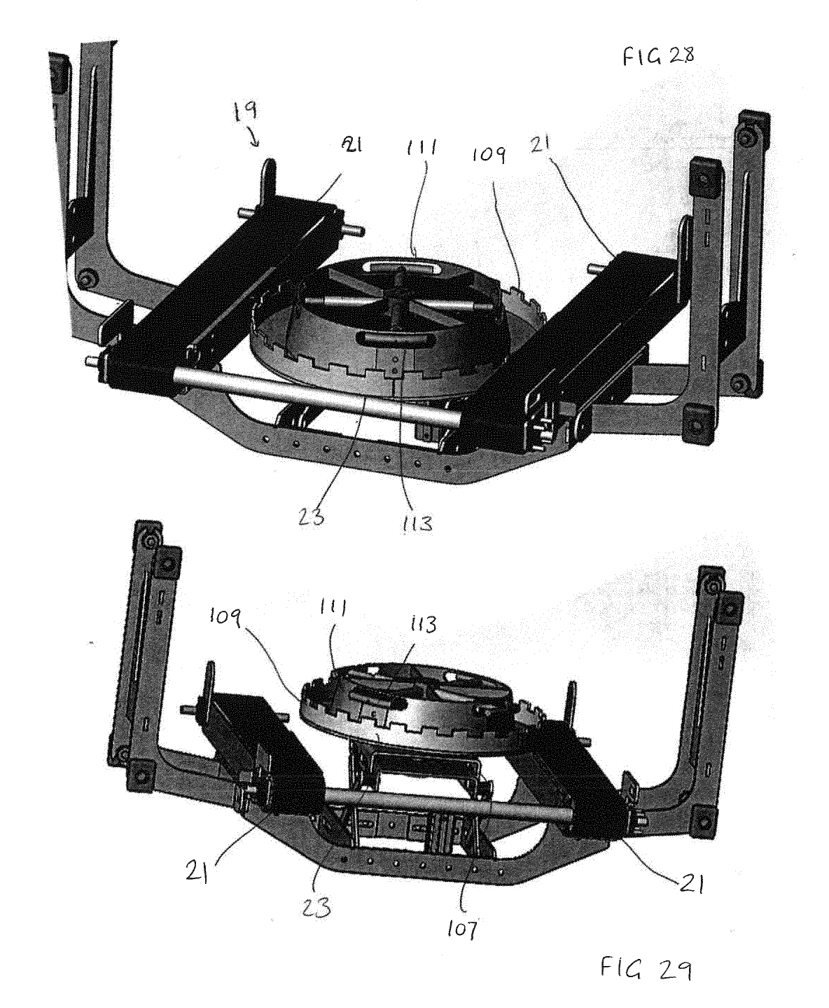

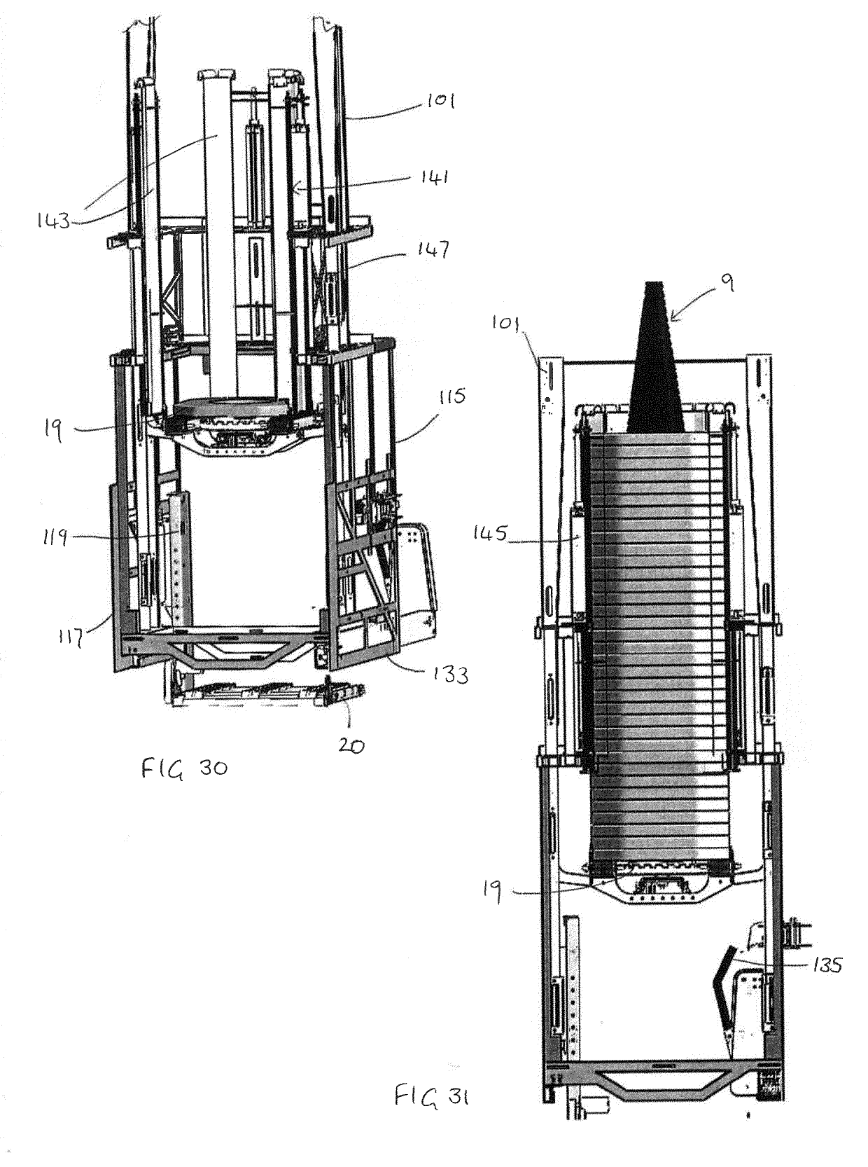

The longer arm of the frame 17 also mounts a clamp assembly 141 for a stack of cones 3. FIG. 30 shows the empty clamp assembly 141, with the first platform 19 at the base of the clamp assembly, while FIG. 31 shows the clamp assembly with a nearly full stack of cones. The clamp assembly has four clamping bars 143 movable between an open position and a closed position for engaging the base 3a of a cone 3 located between the clamping bars 143. In this embodiment there are four clamping bars but this is not limiting and the number of clamping bars may be altered, for example fewer or more clamping bars may be employed. The clamping bars 143 may be operated by any suitable means such as powered rams 145 and scissor linkages 147. The clamp assembly is also movable vertically on the tower 11. FIG. 27 shows the assembly in an upper position in the frame 17 used for the dispensing and retrieving of cones 3, while FIG. 30 shows the assembly in a lower, transfer, position, from which the clamp assembly can be swung out of alignment with the tower and over the flatbed storage area 7, such that a stack 9 of cones 3 can be moved from the flatbed storage area 7 to the tower 11, or from the tower 11 to the flatbed storage area 7. FIG. 31 shows the platform 19 supporting a stack 9 of cones 3 with the clamp assembly 141 open. FIG. 32 shows the clamp assembly 141 in position to pick up or drop off a stack of cones, being cantilevered out over the flatbed area by means of the pivoting links 149,151.

The components are actuated by motors (not shown), which may be operated by switches (not shown) in turn operated by movement of the components, or by the control unit as described above.

To dispense cones 3, the empty clamp assembly is swung out to the position of FIG. 32, with the clamping bars 143 open. The clamping bars 143 close to pick up a stack 9 of cones, and the assembly is then swung back into the tower 11, and raised to the upper position of FIG. 27. The first platform 19 is then raised so that it engages with the base cone of the stack 9. The turntable is raised and the gripping members moved outwardly to grip the inside of the cone 3. The clamping bars 143 are then opened and the first platform 19 lowered slightly to move the base cone 3 away from the bars 143. The clamping bars 143 are then closed to clamp the remaining cones of the stack 9.

As a result, the cone 3 at the bottom of the stack 9 is released from the stack 9 and, supported on the platform 19, moves with the platform 19 from the upper transfer position 105 to the lower transfer position 103, while the remaining cones 3 in the stack 9 are retained in the elevated position at the upper end of the tower 11 by the clamping bars 143.

Meanwhile, the second platform 20 is in the position shown in FIG. 33, in the retracted position level with the lower transfer position 103, while the anti-skid assembly 127 and the toppler assembly 129 are in the retracted positions shown, with the anti-skid arm 135 raised. As the first platform 19 descends, the second platform 20 moves outwardly, to the position shown in FIG. 34. It is still level with the first platform 19 when that reaches the lower transfer position 103. The grippers 113 are retracted to release the cone and the turntable 23 retracted. The powered belts 21 on the sides of the platform 19 are operable to move the cone 3 outwards from the platform 19 onto the platform 20.

The second platform 20 is then lowered to the position shown in FIG. 27 and its belts 125 powered to dispense the cone 3 onto the road. The second platform 20 is then raised again to the position shown in FIG. 34. Once the cone 3 has transferred from the first platform 19 to the second platform 20, the first platform 19 is raised up to the position 105 and the stack 9 to engage the new base cone of the stack 9, while the original cone is being dispensed onto the road.

The operation described above is repeated with the new base cone in order to dispense it, and then with subsequent cones until all the cones 3 in the stack 9 have been dispensed.

As the last cone 3 in the stack 9 is lowered by the first platform 19 for dispensing, the clamp assembly 141 is swung out of alignment with the tower 1 land over the flatbed storage area 7, to pick up another stack 9 of cones 3 from the flatbed storage area 7, the clamp assembly 141 then being swung back into alignment with the tower 11 so that the new stack 9 is ready for dispensing. The dispensing operation can therefore be continued without interruption and can be repeated until all the stacks of cones 3 in the flat bed storage area 7 have been transferred to the tower 11 and dispensed or until sufficient cones 3 have been dispensed to demarcate the required section of the road. The shuttle device 79 of FIG. 19 can be used for transferring a stack of cones between the conveyor and the tower. In this way, the further device can receive the next stack of cones to be dispensed from the storage area and move the stack to align with the tower while the tower is dispensing cones from a previous stack of cones. In this way, the tower may not have to be moved to receive the next stack of cones from the storage area so that dispense of cones may continue without interruption.

Where the cones 3 are stacked in rows, transfer of the stacks 9 from the flat bed storage area 7 to the tower 11 may be controlled by the control unit to maintain a balanced load. For example, the tower 11 may receive a stack 9 of cones 3 from each row in turn or any other sequence to maintain a balanced load in the storage area.

In a modification of the above operation, the first platform 19 and clamp assembly 141 can be controlled so that two or more cones 3 can be released from the stack 9 at the same time and dispensed onto the road stacked on top of each other. This may be desirable, for example in windy conditions, to provide additional weight and stability so that the cones 3 stay in position on the road.

To retrieve the cones 3, the vehicle is driven in reverse. Cameras may be provided at the rear of the vehicle and in the driver's cab to assist the driver to position the tower 11 in line with the cones 3 on the road.

Sensors on the tower 11 and/or cone 3 may provide fine adjustment for accurately positioning the tower 11 in line with the cones to be retrieved. Any suitable sensors may be employed. Preferably the sensors are capable of operating under all conditions including at night when the volume of traffic using the road is often lower than in the day and it is more convenient to retrieve cones from the road. The sensors may be of any suitable type, for example infra-red sensors or laser sensors.

Retrieving the cones 3 is more difficult than dispensing them, because they need to be raised onto the second platform 20, and may tend to skid on the road and fall over. Retrieval therefore requires the use of the anti-skid mechanism 127 and the toppler assembly 129, as shown in FIGS. 33 to 40.

From the retracted position shown in FIG. 33, the anti-skid slider 131 is moved outwardly, as is the second platform 20, to the position shown in FIG. 34, in which the toppler assembly 129 is also pivoted out into an operative position. Next, the second platform 20 is lowered and moved inwardly, as shown in FIG. 35, which also shows a cone 3 about to contact the toppler collar 137. It will be appreciated that the configuration of the toppler collar 137 is chosen to suit the shape of the cone 3.

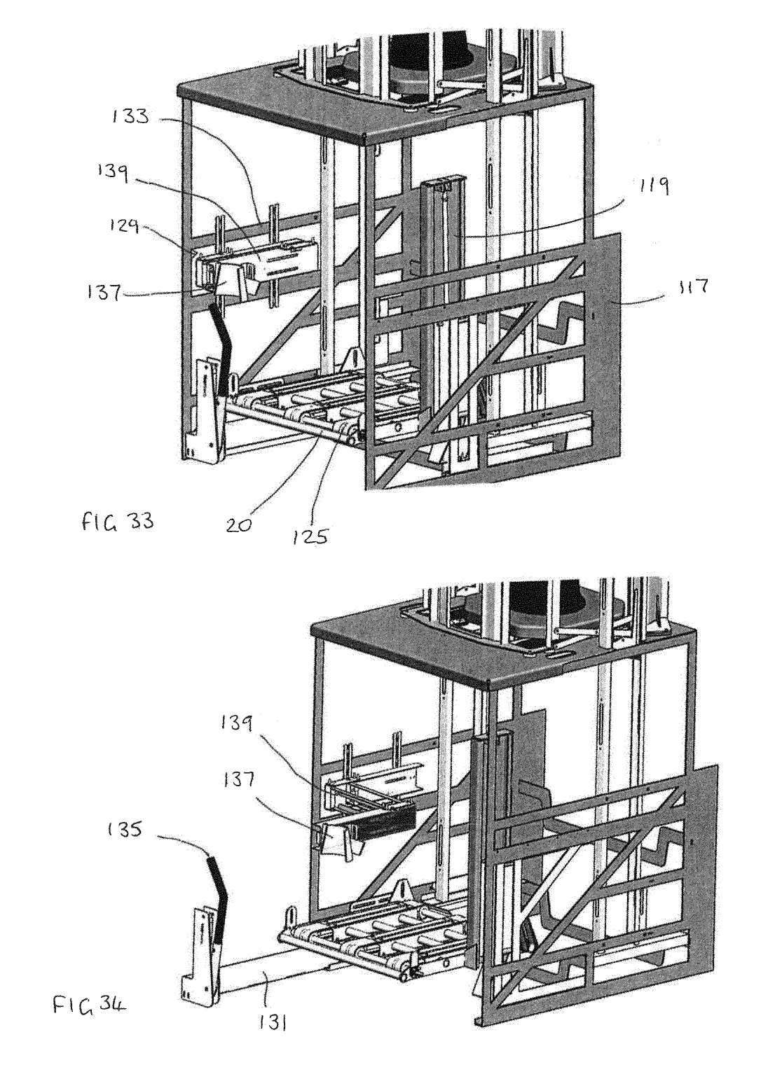

As shown in FIG. 36, the cone 3 rotates the toppler collar 137, operating a switch (not shown) which moves the anti-skid slider 131 inwardly, lowers the anti-skid arm 135 starts the belts 125 on the second platform 20. As a result, the cone 3 starts to tilt to an angle relative to the road. It is prevented from skidding by the anti-skid arm 135 and tilts sufficiently so that the second platform 20 can access beyond the centre of the base 3a of the cone 3 to retrieve the cone 3 and the belts bring it onto the platform 20. The tilt angle may be approximately 35 degrees although this may change according to the shape and size of the base 3a of the cone 3.

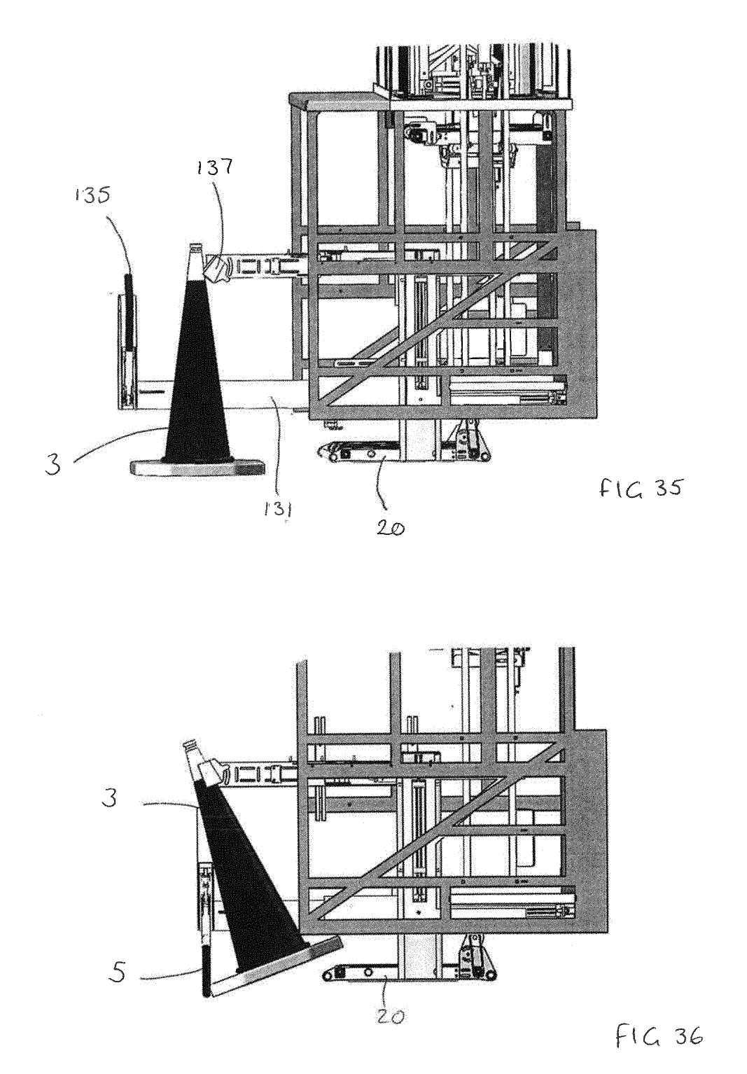

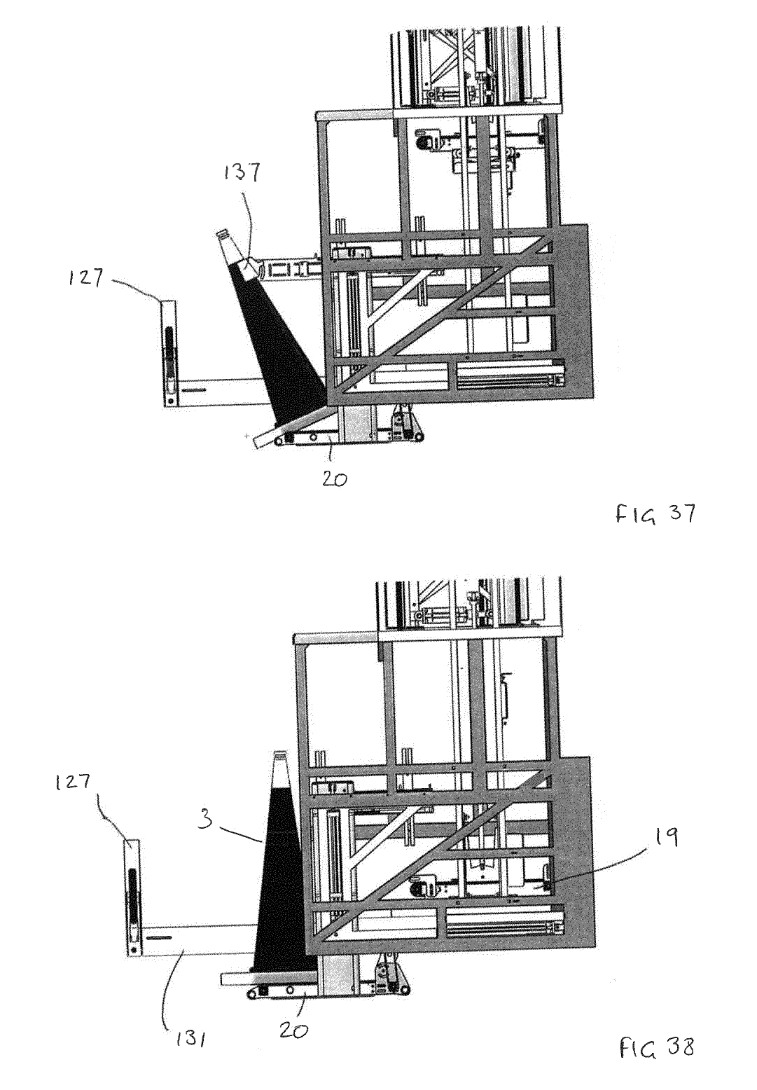

As the cone 3 moves onto the second platform 20 it rotates the toppler collar 137 to operate a further switch (not shown), to raise the anti-skid arm 135, and move the move the second platform 20 and the anti-skid slider 131 outwardly again, as shown in FIG. 37. The toppler assembly 129 is then returned to its retracted position, once the cone 3 is securely on the second platform 20, so that the cone 3 can be transferred to the first platform 19.

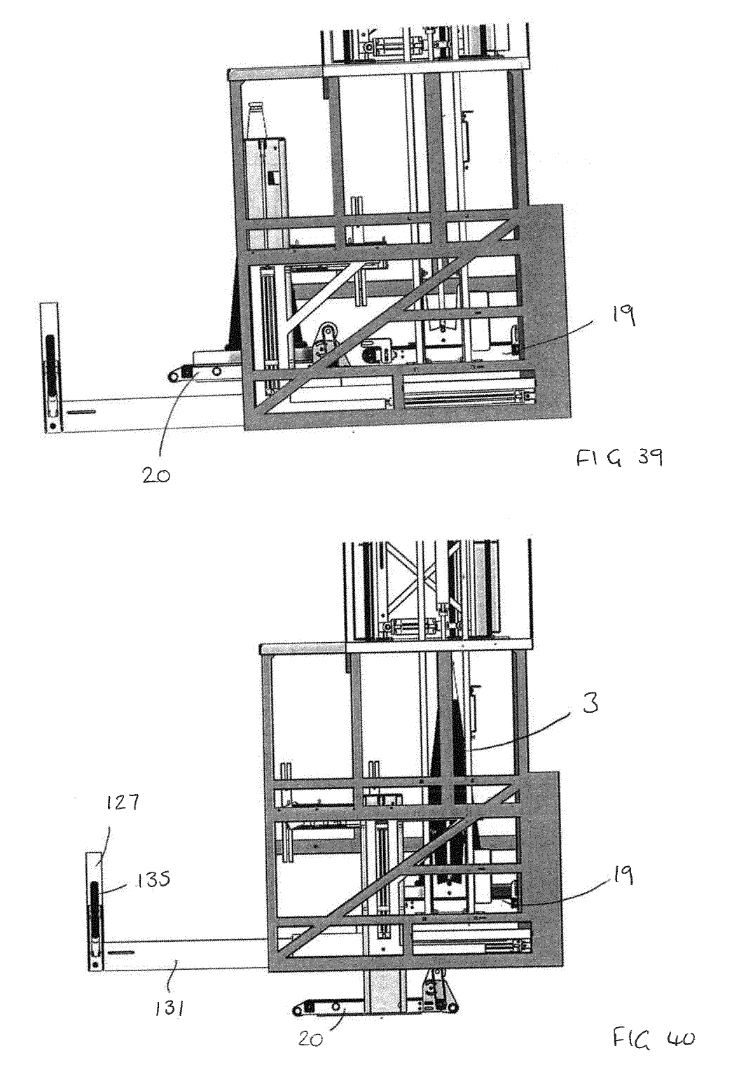

The first platform 19, which has been in the raised position, is lowered to the transfer position 103, with its turntable 23 retracted, as shown in FIG. 38, and then the second platform 20 is raised to the transfer position 103, and the belts 125 and 21 powered to transfer the cone 3 to the first platform 19, as shown in FIG. 39. The second platform 20 is lowered again and moved inwardly and the toppler assembly 129 moved into the operative position ready to retrieve the next cone 3 while the first platform 19 is operated to stack the original cone 3.

FIG. 40 shows the first platform starting to lift the cone 3, the second platform 20 lowered, and before the toppler assembly 129 is moved to the operative position.

The first platform 19 is then raised to lift the cone 3 with the clamp assembly 141 closed to position the base 3a of the retrieved cone 3 at the base of the clamp assembly. The clamping bars 143 are opened and the cone 3 lifted to position the base 3a of the retrieved cone 3 within the clamping bars 143.

As a result, when the clamping bars 143 are closed, the retrieved cone 3 is supported on and held in the elevated position by the clamping bars when the first platform 19 is lowered to receive the next cone 3 retrieved from the road.

If one or more cones 3 are already supported by the clamping bars when the first platform 19 is raised, the body 3b of the retrieved cone 3 on the platform 19 is received within the body 3b of the bottom cone 3 of the stack. When the clamping bars 143 are opened, the first platform 19 is raised by one cone base to lift the stack of cones and position the base 3a of the retrieved cone 3 within the clamping bars.

As a result, when the clamping bars 143 are closed, the stack of cones including the retrieved cone 3 is supported on and held in the elevated position by the clamping bars when the platform 19 is lowered to receive the next cone 3 retrieved from the road. This operation is repeated to reform a stack 9 of cones 3 within the tower 11.

After the second to last cone 3 to re-form a complete stack 9 of cones 3 is in the stack, the clamp assembly 141 is lowered to an intermediate transfer position to receive the last cone 3, and the clamp assembly 141 can be swung out of alignment with the tower 11 and over the flatbed storage area 7, such that the stack 9 of cones 3 can be moved to the flatbed storage area 7 from the tower 11. The clamping bars 143 are moved to the open position so that the complete stack 9 of cones 3 can be deposited onto the further device as described above for transferring a stack of cones between the conveyor and the tower. In this way, the device can move the stack of cones to be returned to the storage area to align with the conveyor on the storage area while the tower is picking up cones to form the next stack of cones. In this way, the tower may not have to be moved to return the stack of cones to the storage area so that retrieval of cones may continue without interruption.

The conveyor then moves the stack 9 of cones 3 towards the front of the flat bed storage area 7 a distance sufficient to allow another stack 9 of cones 3 to be returned from the tower 11 to re-form the row of stacked cones 3. The return of stacks of cones from the tower 11 to the flat bed storage area 7 may be controlled by the control unit to maintain a balanced load. For example, the stacks 9 of cones 3 may be returned to the rows in turn or any other sequence to maintain a balanced load in the storage area. This operation is repeated until all the cones 3 are recovered.

As will be understood, the above operation to dispense and retrieve the cones 3 is fully automated, does not require any manual lifting of the cones 3 and can be carried out by the drive 11 of the vehicle without any additional operators. It will be appreciated however, that the tower 11 may be employed without the conveyors on the flat bed storage area 7 and that the stacks 9 of cones 3 on the flat bed storage area 7 may be manually inserted into the tower 11 and retrieved from the tower 11.

Dispensing and retrieving of the cones may be combined with fitting/removing lamps on the cones and/or washing the cones as is known.

Other modifications and changes that can be made within the concepts described herein will be apparent to those skilled in the art. Features of any of the embodiments may be employed separately or in combination with any other feature of the same or different embodiments without limitation.

What is claimed is:

1. An apparatus for dispensing cones onto a surface and for retrieving cones from the surface, the apparatus including a cone transfer device for transferring cones between a vehicle and the surface, the cone transfer device including a tower having a platform moveable to and from a lower transfer position for dispensing cones onto the surface and for retrieving cones from the surface, the cone transfer device including a device for tilting cones to be retrieved from the surface, and an anti-skid mechanism deployed as cones are retrieved to prevent cones from skidding when in a tilted position.

2. The apparatus according to claim 1, including a second platform for dispensing cones onto the road and for retrieving cones from the road, the first platform being movable to and from a first transfer position, and the second platform being movable between the first transfer position and a second transfer position, and between outward and inward transfer positions to dispense cones onto the road and retrieve cones from the road,

3. The apparatus according to claim 1, wherein the first platform includes a securing member adapted to engage in the interior of a cone in order to stabilise it on the platform.

4. The apparatus according to claim 3, wherein the securing member is frusto-conical in order to engage securely in the cone.

5. The apparatus according to claim 3, wherein the securing member is a turntable, for rotating the cones.

6. The apparatus according to claim 3, wherein the securing member is provided with gripping members movable into engagement with the interior of a cone, the gripping members moving radially into and out of engagement with the interior of the cone.

7. The apparatus according to claim 1, wherein the second platform is provided with conveyor means for transferring cones onto and off the second platform.

8. The apparatus according to claim 1, wherein the cone tilting device comprises a retractable toppler assembly, including a toppler collar adapted to engage the outside of a cone to start it tilting as it is retrieved.

9. The apparatus according to claim 1, wherein the anti-skid mechanism comprises a slider mounted on the tower and movable inwardly and outwardly.

10. The apparatus according to claim 9, wherein the slider carries an anti-skid arm which can be lowered to contact a cone being retrieved to stop it skidding on the road as it is tilted by the cone tilting device.

11. The apparatus according to claim 1 wherein the platform is movable in a vertical direction between the lower transfer position and an upper transfer position for receiving cones from a storage area and for returning cones to the storage area.

12. An apparatus for dispensing cones onto a surface and for retrieving cones from the surface, the apparatus comprising a cone transfer device for transferring cones between a vehicle and the surface, the cone transfer device including a tower having a first platform movable to and from a first transfer position for dispensing cones onto the road and for retrieving cones from the road, and a transfer assembly movable independently of the first platform to transfer a stack of cones between the tower and the vehicle.

13. The apparatus according to claim 12, wherein the transfer assembly comprises a clamp assembly mounted in the tower and movable within the tower, and away from the tower towards the vehicle.

14. The apparatus according to claim 13, wherein clamp assembly includes clamping bars movable between a closed position and an open position to retain cones in an elevated position from which cones can be released onto the platform individually or in multiples of two or more cones.

15. An apparatus for dispensing cones onto a surface and for retrieving cones from the surface, the device comprising a cone transfer device for transferring cones between a vehicle and the surface, the cone transfer device including a tower having a first platform movable to and from a lower transfer position for dispensing cones onto the road and for retrieving cones from the road, the first platform including a securing mechanism for engaging the internal surface of a cone.

16. The apparatus according to claim 15, wherein the securing mechanism includes a securing member adapted to engage in the interior of a cone in order to stabilise it on the first platform.

17. The apparatus according to claim 1, including a lamp transfer device for attaching a lamp unit to a cone when the cone is dispensed and for removing the lamp unit from the cone when the cone is retrieved.

18. The apparatus according to claim 1 including a cone washing device for washing a cone when the cone is retrieved and/or when the cone is dispensed.
